(19) United States
(12) Patent Application Publication
(10) Pub. No.: US 2007/0022479 A1
(43) Pub. Date: Jan. 25, 2007

(54) Network interface and firewall device

(76) Inventors: Somsubhra Sikdar, San Jose, CA (US); Kevin Jerome Rowett, Cupertino, CA (US); Caveh Jalali, Redwood City, CA (US); Steven Clay Ellis, Los Gatos, CA (US)

Correspondence Address: MARGER JOHNSON & MCCOLLOM, P.C., 210 SW MORRISON STREET, SUITE 400, PORTLAND, OR, 97204, US

(21) Appl. No.: 11/187,049

(22) Filed: Jul. 21, 2005

(51) Int. Cl. G06F 12/14; G06F 11/00; G06F 12/16; G06F 15/18; G08B 23/00; G06F 15/16; G06F 17/00; G06F 9/00

(52) U.S. Cl. 726/22; 726/23; 726/25; 726/11

(57) ABSTRACT

A network processing device provides a novel architecture for conducting firewall and other network interface management operations. In another aspect of the invention, a Unified Policy Management (UPM) architecture uses a same memory and processing structure to integrate firewall policy management with routing and switching decisions. In another embodiment, a Reconfigurable Semantic Processor (RSP) uses a parser to identify different syntactic elements that are then used by one or more Semantic Processing Units (SPUs) to carry out different firewall, network interface, routing, switching, and other packet processing operations.

### BACKGROUND

The openness of the Internet has lead to the creation of various attacks upon Internet connected machines. These attacks work by sending packet sequences that cause the target machine to no longer operate correctly. The attacks can be classified into categories such as crashing the target machine, Denial of Service (DoS), Distributed Denial of Service (DDoS), and alter the files or software of the target machine such that the machine is no longer usable, corrupted, or operates as a clone attack source for a DoS.

Most attacks originate on machines connected to the public Internet and enter an enterprise through that company's connection to the Internet. Some enterprises have more than one point of connection to the Internet. Accordingly, a network device, alternatively referred to as a firewall, located at the interface between the two networks is used to defend against these attacks. For example, the firewall can be located between the public Internet and a private network, between two Internet Service Provider (ISP) networks, between two Local Area Networks, or between any other two networks. If a firewall device is placed at all points of connection to the Internet, then a perimeter firewall is formed around the internal network and machines.

The firewall has the responsibility of removing unauthorized attacks from entering the private network and possibly removing unauthorized transmissions that may originate from inside the private network. Other uses for the firewall may include modifying information inside the packets. For example, the firewall can be used as a Network Address Translator (NAT) for converting between public and private Internet Protocol (IP) addresses.

To date, firewall operations have primarily been implemented as a collection of software modules running on either an embedded processor, such as the PowerPC®, or an Intel® class x86 processor. The problem is that these hardware architectures do not have the processing capacity to effectively implement these firewall operations. Thus, it is difficult, if not impossible, to defend or filter out all the various attacks by examining each packet as it flows from source to destination and applying various rules to determine the packets validity.

The present invention addresses this and other problems associated with the prior art.

### SUMMARY OF THE INVENTION

A network processing device provides a novel architecture for conducting firewall and other network interface management operations. In another aspect of the invention, a Unified Policy Management (UPM) architecture uses a same memory and processing structure to integrate firewall policy management with routing and switching decisions. In another embodiment, a Reconfigurable Semantic Processor (RSP) uses a parser to identify different syntactic elements that are then used by one or more Semantic Processing Units (SPUs) to carry out different firewall, network interface, routing, switching, and other packet processing operations.

The foregoing and other objects, features and advantages of the invention will become more readily apparent from the following detailed description of a preferred embodiment of the invention which proceeds with reference to the accompanying drawings.

### BRIEF DESCRIPTION OF THE DRAWINGS

FIG. 1 is a block diagram of a network processing device that uses a Reconfigurable Semantic Processor (RSP).

FIG. 2A is a block diagram showing the RSP in more detail.

FIGS. 2B and 2C are more detailed diagrams showing a parser table and production rule table used in the RSP.

FIG. 3 is a diagram showing how a Denial of Service (DoS) attack can disable a network processing device.

FIG. 4 is a diagram showing how a firewall associates DoS attacks with different zones.

FIG. 5 is a more detailed diagram of the firewall shown in FIG. 4.

FIG. 6 shows how a memory in the firewall may be partitioned into different generations.

FIG. 7 is a flow diagram showing how the firewall moves between the different generations shown in FIG. 6.

FIG. 8 is a flow diagram showing how the firewall in FIG. 5 processes DoS attacks.

FIG. 9 is a block diagram showing one implementation of how the RSP previously shown in FIG. 2A is configured for handling DoS attacks.

FIGS. 10 and 11 are flow diagrams showing how the RSP in FIG. 9 processes DoS candidate packets.

FIG. 12 is a block diagram showing an independently operating firewall and routing device.

FIG. 13 is a diagram of a packet processing architecture that provides unified routing and firewall policy management (UPM).

FIG. 14 is a diagram showing sample entries in an Access Control List (ACL) table.

FIG. 15 is a flow diagram showing how the packet processor in FIG. 13 provides UPM.

FIG. 16 is another example of a UPM table that provides forwarding actions based on upper layer packet characteristics.

FIG. 17 is a block diagram showing one example of how UPM can be used to route packets according to different Uniform Resource Locator (URL) values.

FIG. 18 is one example of how Uniform Policy Management is implemented in the RSP.

FIG. 19 is a flow diagram showing how the RSP in FIG. 18 operates.

FIG. 20 is a diagram showing how the RSP is used for Network Address Translation (NAT) and Port Address Translation (PAT).

FIG. 21 is a more detailed diagram showing how the RSP is configured for NAT/PAT translation and IP packet translation.

FIGS. 22 and 23 are flow diagrams showing how the RSP conducts NAT/PAT translation.

FIG. 24 is a diagram showing how the RSP converts packets between IPv4 and IPv6.

FIG. 25 is a flow diagram showing in more detail how the RSP converts between IPv4 and IPv6.

FIGS. 26 and 27 show how the RSP is used for Virtual Private Network (VPN) integration.

FIGS. 28 and 29 show how the firewall can be used for allocating anti-virus licenses to different sub-networks.

FIGS. 30 and 31 show how multiple RSPs can be connected together for distributed firewall processing.

### DETAILED DESCRIPTION

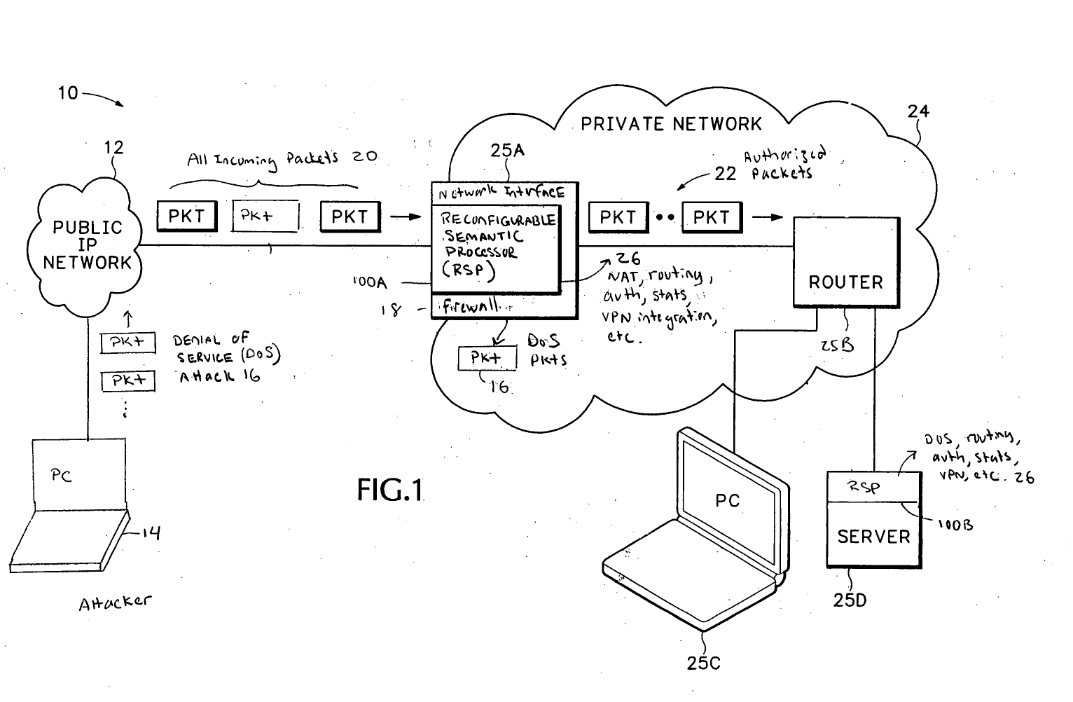

FIG. 1 shows a private Internet Protocol (IP) network 24 that is connected to a public IP network 12 through a network interface device 25A. The public IP network 12 can be any Wide Area Network (WAN) that provides packet switching. The private network 24 can be a company enterprise network, Internet Service Provider (ISP) network, home network, etc. that needs to communicate with the public IP network 12.

Network processing devices 25A-25D in private network 24 can be any type of computing equipment that communicate over a packet switched network. For example, the network processing devices 25A and 25B may be a routers, switches, gateways, firewalls, etc. The endpoint 25C is a Personal Computer (PC) and endpoint 25D is a server, such as an Internet Web server. The PC 25C can be connected to the private network 24 via either a wired connection such as a wired Ethernet connection or a wireless connection using, for example, the IEEE 802.11 protocol.

Reconfigurable Semantic Processors (RSPs) 100 operate in any combination of the network devices 25A-25D in private network 24. The different RSPs 100 collect and analyze network traffic 22 that passes both into and through the private network 24. The RSP 100A in network processing device 25A, in this example, is configured to operate as a firewall and general network interface for private network 24. While the network interface and other general firewall operations described below are shown implemented in RSP 100, it should be understood, that some of these operations can also be implemented in other conventional computer architectures.

In one example, the RSP 100A is configured to detect and protect against Denial of Service (DoS) attacks 16. An external PC 14 connected to the public IP network 12 may generate a DoS attack 16 that is intended to bring down one or more of the network processing devices 25A-25D in private network 24. The RSP 100A monitors all incoming packets 20 received from the public IP network 12 and discards any packets in the packet stream 20 associated with DoS attack 16. In addition to detecting and discarding the packets 16, the RSP 100A can also perform other network interface operations 26 on packets 22 that are not dropped pursuant to DoS attack 16. For example, the RSP 100A can provide virus and malware detection and filtering, Network Address Translation (NAT), routing, statistic analysis, logging, and/or other packet conversion operations that are required for packets transmitted between public IP network 12 and private IP network 24. All these operations will be described in more detail below.

In another example, the RSP 100 may be installed in other network processing devices located internally in the private network 24, or at any other primary access point into private network 24. For example, the RSP 100B may be located in the server 25D in order to provide similar authentication, routing, statistical analysis, etc. operations 26 that will be described in more detail below. Alternatively, some of the packet operations 26 may be enabled in RSP 100B and not enabled in RSP 100A. For example, the RSP 100B may conduct statistical analysis or DoS filtering, in addition to any other packet analysis filtering and packet translations performed by RSP 100A.

Any other network processing devices 25B and 25C in the private network 24 can also include one or more RSPs 100 that are configured to perform any of the operations described below. The platform that uses the RSP 100 can also be any wireless device such as a wireless Personal Digital Assistant (PDA), wireless cell phone, wireless router, wireless Access Point, wireless client, etc. that receives packets or other data streams over a wireless interface such as cellular Code Division Multiple Access (CDMA) or Time Division Multiple Access (TDMA), 802.11, Bluetooth, etc.

Reconfigurable Semantic Processor (RSP)

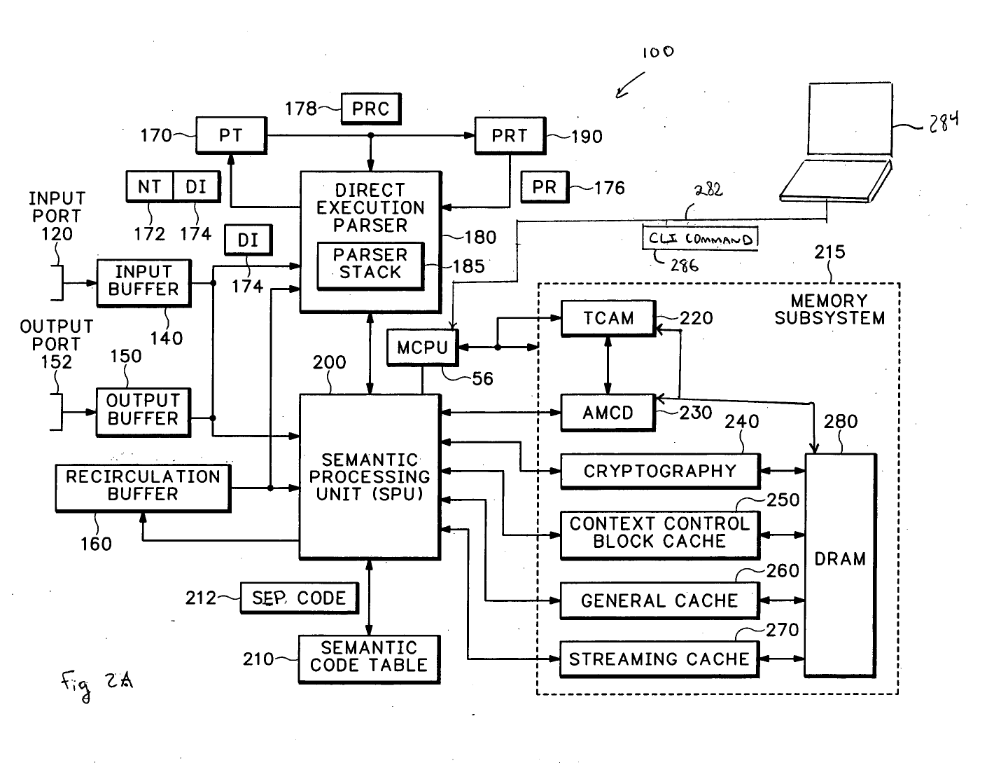

FIG. 2A shows a block diagram of the Reconfigurable Semantic Processor (RSP) 100 used in one embodiment for implementing the firewall and other network interface operations described below. The RSP 100 contains an input buffer 140 for buffering a packet data stream received through the input port 120 and an output buffer 150 for buffering the packet data stream output through output port 152.

A Direct Execution Parser (DXP) 180 controls the processing of packets or frames received at the input buffer 140 (e.g., the input “stream”), output to the output buffer 150 (e.g., the output “stream”), and re-circulated in a recirculation buffer 160 (e.g., the recirculation “stream”). The input buffer 140, output buffer 150, and recirculation buffer 160 are preferably first-in-first-out (FIFO) buffers.

The DXP 180 also controls the processing of packets by a Semantic Processing Unit (SPU) 200 that handles the transfer of data between buffers 140, 150 and 160 and a memory subsystem 215. The memory subsystem 215 stores the packets received from the input port 120 and also stores an Access Control List (ACL) table in CAM 220 used for Unified Policy Management (UPM) operations and other firewall operations that are described below.

The RSP 100 uses at least three tables to perform a given firewall operation. Codes 178 for retrieving production rules 176 are stored in a Parser Table (PT) 170. Grammatical production rules 176 are stored in a Production Rule Table (PRT) 190. Code segments 212 executed by SPU 200 are stored in a Semantic Code Table (SCT) 210. Codes 178 in parser table 170 are stored, e.g., in a row-column format or a content-addressable format. In a row-column format, the rows of the parser table 170 are indexed by a non-terminal code NT 172 provided by an internal parser stack 185. Columns of the parser table 170 are indexed by an input data value DI[N] 174 extracted from the head of the data in input buffer 140. In a content-addressable format, a concatenation of the non-terminal code 172 from parser stack 185 and the input data value 174 from input buffer 140 provide the input to the parser table 170.

The production rule table 190 is indexed by the codes 178 from parser table 170. The tables 170 and 190 can be linked as shown in FIG. 2A, such that a query to the parser table 170 will directly return a production rule 176 applicable to the non-terminal code 172 and input data value 174. The DXP 180 replaces the non-terminal code at the top of parser stack 185 with the production rule (PR) 176 returned from the PRT 190, and continues to parse data from input buffer 140.

The semantic code table 210 is also indexed according to the codes 178 generated by parser table 170, and/or according to the production rules 176 generated by production rule table 190. Generally, parsing results allow DXP 180 to detect whether, for a given production rule 176, a Semantic Entry Point (SEP) routine 212 from semantic code table 210 should be loaded and executed by SPU 200.

The SPU 200 has several access paths to memory subsystem 215 which provide a structured memory interface that is addressable by contextual symbols. Memory subsystem 215, parser table 170, production rule table 190, and semantic code table 210 may use on-chip memory, external memory devices such as synchronous Dynamic Random Access Memory (DRAM)s and Content Addressable Memory (CAM)s, or a combination of such resources. Each table or context may merely provide a contextual interface to a shared physical memory space with one or more of the other tables or contexts.

A Maintenance Central Processing Unit (MCPU) 56 is coupled between the SPU 200 and memory subsystem 215. MCPU 56 performs any desired functions for RSP 100 that can reasonably be accomplished with traditional software and hardware. These functions are usually infrequent, non-time-critical functions that do not warrant inclusion in SCT 210 due to complexity. Preferably, MCPU 56 also has the capability to request the SPU 200 to perform tasks on the MCPU's behalf.

The memory subsystem 215 contains an Array Machine-Context Data Memory (AMCD) 230 for accessing data in DRAM 280 through a hashing function or content-addressable memory (CAM) lookup. A cryptography block 240 encrypts, decrypts, or authenticates data and a context control block cache 250 caches context control blocks to and from DRAM 280. A general cache 260 caches data used in basic operations and a streaming cache 270 caches data streams as they are being written to and read from DRAM 280. The context control block cache 250 is preferably a software-controlled cache, i.e. the SPU 200 determines when a cache line is used and freed. Each of the circuits 240, 250, 260 and 270 are coupled between the DRAM 280 and the SPU 200. A TCAM 220 is coupled between the AMCD 230 and the MCPU 56 and contains an Access Control List (ACL) table and other parameters in a manner that substantially improves firewall performance.

Detailed design optimizations for the functional blocks of RSP 100 are described in co-pending application Ser. No. 10/351,030, entitled: A Reconfigurable Semantic Processor, filed Jan. 24, 2003 which is herein incorporated herein by reference.

Using the RSP for Firewall and Network Interface Operations

The firewall and other network interface operations 26 described above in FIG. 1 are implemented with the RSP 100 using grammar rules and Semantic Entry Point (SEP) routines 212. Packets arrive at the input port 120 of the RSP device 100, are parsed with the grammar table entries in parser table 170 and semantically processed by the SEP routines 212. The SEP routines 212 will decide to:
1. Accept the packet as is, passing it onto the output port 152;
2. Drop the packet from further processing, and not forward it;
3. Modify the packet, and then send it onto the output port 152;
4. Hold the packet, waiting for further packets of the session to arrive, then determine the final disposition of the packet; or
5. Steer the packet to a particular destination or back through the RSP for additional processing.

The grammar rules in parser table 170 are constructed to allow acceptable packets to pass, and to flag to a SPU 200 a known or suspected anomaly. One example of the grammars determining pass or fail includes TCP flag settings. The TCP flag field has 8 bits in it and only certain combinations are valid. The grammar rules are coded in parser table 170 to allow all acceptable TCP settings, and reject unacceptable TCP settings. For example, a TCP SYN and FIN message both set in the same packet is not a valid combination and is therefore dropped directly by the DXP 180.

Some unacceptable packets or operations may only be determined by the supporting SEP routines 212. These mostly involve the state of the session and protocol. An example would be sending a TCP data payload segment, before sending in a corresponding TCP SYN message. In this example, the SEP routines 212 would drop the packets from memory 280 for TCP sessions that are not preceded by the TCP SYN message.

Use of parser grammars in conjunction with SEP code 212 provide better performance since the direct execution parser 180 can directly reject packets or redirect non-attacking packets around DoS processing without consuming additional cycles in SPUs 200. Traditional firewalls must check each packet against a list of “bad” rules. This is grows over time, as new attacks are discovered. Conversely, the parser grammar can be written to describe and allow only good packets to flow thru the RSP 100. Thus, the bad packets are either automatically filtered out, or directly processed by the SPUs 200. This provides better scaling of packet monitoring operations.

RSP Parser and Production Rule tables

The operation of the RSP 100 as a firewall or Unified Policy Manager (UPM) will be better understood with a specific example. In the example described below, the RSP 100 provides Denial of Service (DoS) filtering of TCP packets. However, those skilled in the art will recognize that the concepts illustrated below are readily applicable to any type of firewall operation for any data stream transmitted using any communication protocol. Similar concepts are also readily applicable to the Unified Policy Management (UPM) operations described below.

The firewall and UPM operations include parsing and detecting a syntax for an input data stream and is explained with reference to FIGS. 2B and 2C. Referring first to FIG. 2B, codes associated with many different grammars can exist at the same time in the parser table 170 and in the production rule table 190. For instance, codes 300 pertain to Media Access Control (MAC) packet header format parsing, codes 302 pertain to IP packet processing, and yet another set of codes 304 pertain to Transmission Control Protocol (TCP) packet processing, etc. Other codes 306 in the parser table 170 pertain to other firewall or Denial of Service (DoS) operations described in more detail below.

The PR codes 178 are used to access a corresponding production rule 176 stored in the production rule table 190. Unless required by a particular lookup implementation, the input values 308 (e.g., a non-terminal (NT) symbol 172 combined with current input values DI[n] 174, where n is a selected match width in bytes) need not be assigned in any particular order in PR table 170.

In one embodiment, the parser table 170 also includes an addressor 310 that receives the NT symbol 172 and data values DI[n] 174 from DXP 180. Addressor 310 concatenates the NT symbol 172 with the data value DI[n] 174, and applies the concatenated value 308 to parser table 170. Although conceptually it is often useful to view the structure of production rule table 170 as a matrix with one PR code 178 for each unique combination of NT code 172 and data values 174, the present invention is not so limited. Different types of memory and memory organization may be appropriate for different applications.

In one embodiment, the parser table 170 is implemented as a Content Addressable Memory (CAM), where addressor 310 uses the NT code 172 and input data values DI[n] 174 as a key for the CAM to look up the PR code 178. Preferably, the CAM is a Ternary CAM (TCAM) populated with TCAM entries. Each TCAM entry comprises an NT code 312 and a DI[n] match value 314. Each NT code 312 can have multiple TCAM entries.

Each bit of the DI[n] match value 314 can be set to “0”, “1”, or “X” (representing “Don't Care”). This capability allows PR codes 178 to require that only certain bits/bytes of DI[n] 174 match a coded pattern in order for parser table 170 to find a match.

For instance, one row of the TCAM can contain an NT code NT_TCP_SYN 312A for a TCP SYN packet, followed by additional bytes 314A representing the contents that may exist in the TCP SYN packet, such as the destination IP address and a TCP message identifier. The remaining bytes of the TCAM row are set to “don't care.” Thus when NT_TCP_SYN 312A and some number of bytes DI[N] are submitted to parser table 170, where the first set of bytes of DI[N] contain the TCP SYN message identifier, a match will occur no matter what the remaining bytes of DI[N] contain.

The TCAM in parser table 170 produces a PR code 178A corresponding to the TCAM entry matching NT 172 and DI[N] 174, as explained above. In this example, the PR code 178A is associated with a TCP SYN packet. The PR code 178A can be sent back to DXP 180, directly to PR table 190, or both. In one embodiment, the PR code 178A is the row index of the TCAM entry producing a match.

FIG. 2C illustrates one possible implementation for production rule table 190. In this embodiment, an addressor 320 receives the PR codes 178 from either DXP 180 or parser table 170, and receives NT symbols 172 from DXP 180. Preferably, the received NT symbol 172 is the same NT symbol 172 that is sent to parser table 170, where it was used to locate the received PR code 178.

Addressor 320 uses these received PR codes 178 and NT symbols 172 to access corresponding production rules 176. Addressor 320 may not be necessary in some implementations, but when used, can be part of DXP 180, part of PRT 190, or an intermediate functional block. An addressor may not be needed, for instance, if parser table 170 or DXP 180 constructs addresses directly.

The production rules 176 stored in production rule table 190 contain three data segments. These data segments include: a symbol segment 177A, a SPU entry point (SEP) segment 177B, and a skip bytes segment 177C. These segments can either be fixed length segments or variable length segments that are, preferably, null-terminated. The symbol segment 177A contains terminal and/or non-terminal symbols to be pushed onto the DXP's parser stack 185 (FIG. 2A). The SEP segment 177B contains SPU Entry Points (SEPs) used by the SPU 200 to process segments of data. In one implementation described below, the SEP segments 177B may correspond to ACL predicates and other syntactic elements that are identified in the currently parsed packet.

The skip bytes segment 177C contains a skip bytes value used by the input buffer 140 to increment its buffer pointer and advance the processing of the input stream. Other information useful in processing production rules can also be stored as part of production rule 176.

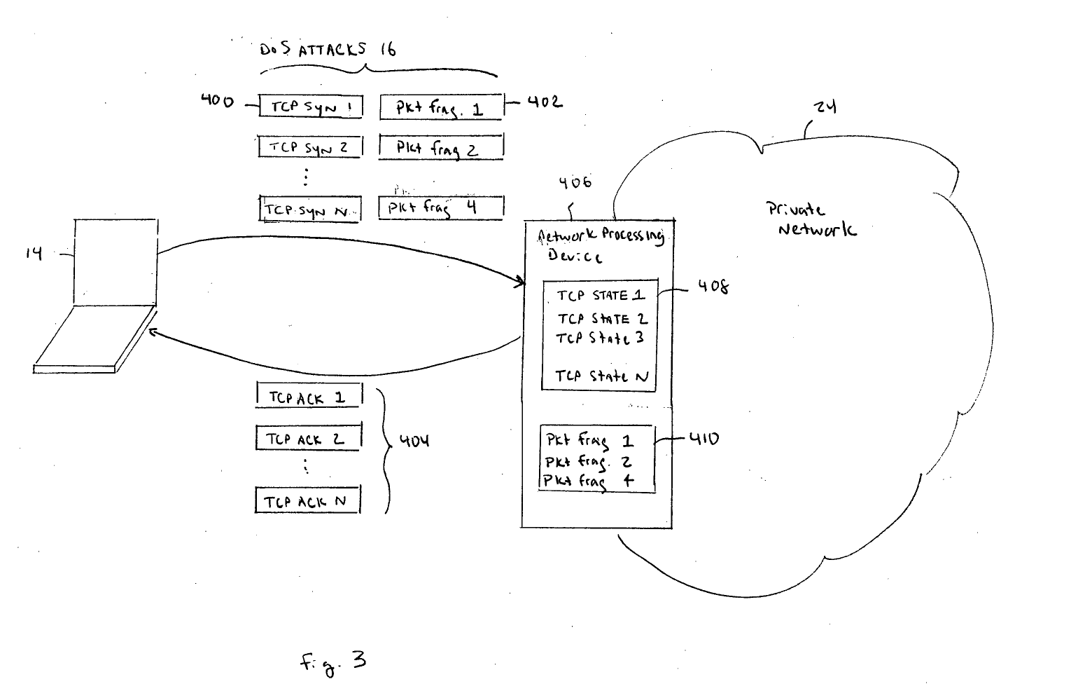

In this example, one or more of the production rules 176A indexed by the production rule code 178A correspond with an identified TCP SYN packet in the input buffer 140. The SEP segment 177B points to SPU code 212 in semantic code table 210 in FIG. 2A that when executed by the SPU 200 performs a DoS operation on the identified TCP SYN packet as described below in FIGS. 4-11.

In one embodiment, the SPU 200 contains an array of semantic processing elements that can be operated in parallel. The SEP segment 177B in production rule 176A may initiate one or more of the SPUs 200 to perform the same firewall operations for different packets or different firewall operations for the same packet in parallel. It should be obvious that a similar operation could be used for detecting any other type of packet or data identification that may be necessary for any of the firewall, network interface, or UPM operations described below.

As mentioned above, the parser table 170 can also include other grammar associated or not associated with the TCP SYN packets. For example, IP grammar 302 contained in parser table 170 may include production rule codes 178 associated with an identified NT_IP destination address in input buffer 140 that is used in combination with the identified TCP SYN message to conduct DoS processing (See FIGS. 4-11 below).

The matching data value 314 in the production rule codes 302 may contain the destination IP address of a network processing device located in the private network 24 in FIG. 1. If the input data DI[I] 174 associated with an NT_IP code 172 does not have the destination address contained in the match values 314 for PR codes 302, a default production rule code 178 may be supplied to production rule table 190. The default production rule code 178 may point to a production rule 176 in the production rule table 190 that directs the DXP 180 and/or SPU 200 to discard the packet from the input buffer 140.

### Denial of service (DoS)

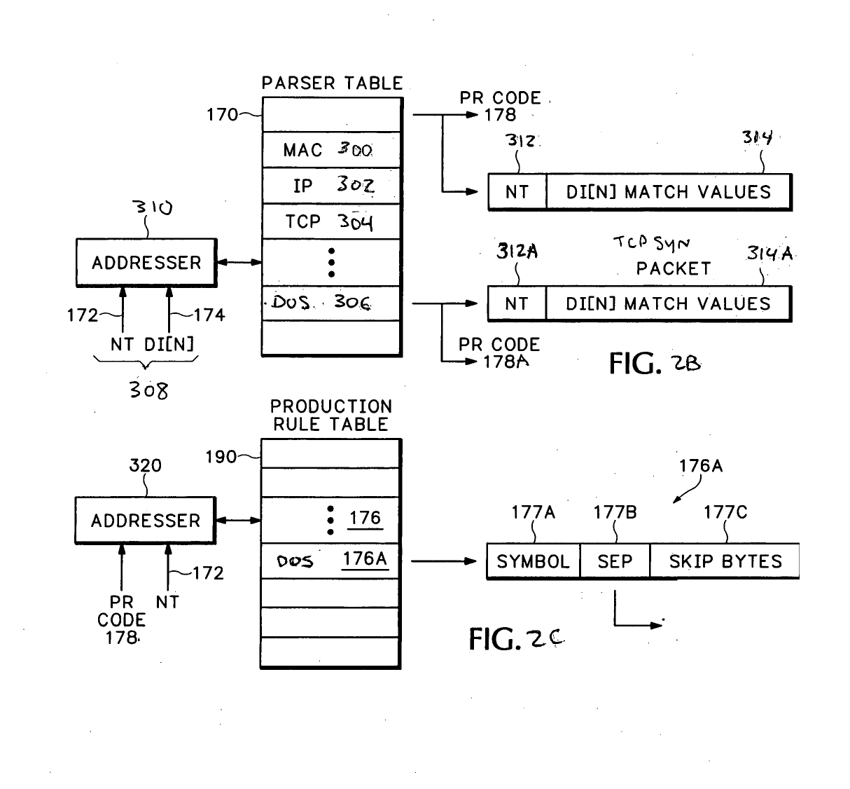

FIG. 3 shows how DoS attacks 16 can compromise a network processing device 406. In general, the purpose of DoS prevention is to prevent malicious packets from gaining access to network processing devices in the private network 24. The description below discusses one example of a DoS attack associated with flooding a network device with multiple packets. However, there are many other types of hostile attacks associated with one, or a few, hostile packets. For example, other hostile attacks can be associated one, or a few, packets that disrupt the normal operation of a network processing device protocol stack. Any of these hostile attacks on a network processing device or network are referred to generally below as DoS attacks and are all within the scope of the present system.

Referring to FIG. 3, an attacking device 14 typically, but not necessarily, operating outside of private network 24 floods the private network 24 with multiple packets 16. In one instance, floods of Transport Control Protocol (TCP) Synchronization (SYN) packets 400 are sent by attacking computer 14 to a destination address in private network 24. In another example, the attacker 14 may send a flood of packet fragments 402 to a destination address in private network 24. In either case, the packets 16 cause one or more network devices 406 in private network 24 to maintain states 408 for each different received TCP SYN packet 400 and maintain states 410 for each set of received packet fragments 402.

The TCP SYN attacks 400 and packet fragment attacks 402 are only examples of the multiple different types of possible DoS attacks. For example, attackers can also bring down network devices by sending TCP Finish (FIN) packets or overlapping packet fragments. In another port based DoS attack, a worm may be located inside a machine in private network 24 that is then directed by attacker 14 to send bogus messages from within the private network 24. The DoS attacks can also be initiated via Internet Control Message Protocol (ICMP) messages.

Whenever a new TCP SYN packet 400 is received by the network processing device 406, a new TCP session state 408 is maintained and a corresponding TCP ACK message 404 sent back to the sending device (attacker 14). However, the attacker 14 may ignore the TCP ACK reply 404 and instead keep sending new TCP SYN messages 400 to the private network 24. The attacker 14 can also insert a bogus source address into the TCP SYN messages 400 that cause network device 406 to send the TCP SYN ACK messages 404 to another computer victim that is then burdened with having to process a flood of TCP SYN ACK messages 404.

The network processing device 406 is required to maintain the TCP states 408 corresponding to each TCP SYN message 400 for some predetermined period of time. The maintenance of this large number of bogus TCP states 408 drains the resources in network device 406 to the point where the processing of other legitimate IP traffic is either severely slowed down or the legitimate IP traffic is dropped.

In a similar scenario, the attacker 14 may send packet fragments 402 that have associated sequence numbers. The network processing device 406 must maintain states 410 until each packet fragment in the sequence 402 is received or until some timeout period has expired. The attacker 14 may intentionally leave out packet fragments 402 from the sequence. This requires the network device 406 to maintain states 410 for each set of packet fragments for the duration of the timeout period thereby exhausting the processing resources.

A conventional technique for defending against these types of DoS attacks is to rate limit the incoming packets 16. For example, the network processing device 406 may identify destination addresses for all TCP SYN packets. The TCP SYN packets for a particular destination address are dropped when the number of received packets rises above a predefined rate.

However, continuously monitoring and tracking each DoS attack uses substantial device resources. The network processing device 406 is required to monitor every incoming packet for each possible DoS threat. For example, the network processing device 406 is required to identify each TCP SYN packet and each packet fragment. This alone is processing intensive. However, the network processing device 406 is also required to track the number and rate of similarly received packets and, if necessary, drop similar types of packets that reach a DoS rate threshold. One problem is that current computer architectures do not have the capacity to conduct these DoS operations at current network line rates.

Referring to FIG. 4, a firewall 420 more efficiently identifies and defends against DoS attacks by rate limiting packets in a unique manner. In the explanation below, any packet that may possibly be part of a DoS attack is referred to as a DoS candidate packet. For example, TCP SYN packets can be used in a DoS attack. Therefore, a TCP SYN packet is identified by firewall 420 as a DoS candidate packet. A fragmented packet can used in a possible DoS attack, and is therefore also identified by firewall 420 as a DoS candidate packet.

The firewall 420 rate limits the DoS candidate packets according to associated destination addresses. Identifying and managing the destination addresses for each possible DoS attack can require substantial processing resources. However, the architecture used in firewall 420 is more efficient and scalable than previous firewall architectures and can therefore monitor and remove a large number of different DoS attacks at high line rates.

Zones

Policy management can assign different zones to a network processing device or network. These different zones, for example, may be associated with different external network and internal network interfaces in the network processing device. These zones may be dictated by network policy management considerations independently of DoS operations. However, one aspect of the firewall 420 takes into consideration the different interface zones previously designated by a policy manager when analyzing DoS threats.

For example, a first zone 1 may be associated with public IP traffic received from public network 12 over interface 426. A second zone 2 may be associated with semi-trusted Virtual Private Network (VPN) traffic received over public network 12 over a VPN tunnel 424. For example, a VPN tunnel 424 may be established between private network 24 and a home computer 422. The home computer 422 may be operated by an employee of the entity operating private network 24. A third zone 3 may be associate with highly trusted IP traffic originating internally from private network 24 and received over interface 428.

Each zone may be associated with a different level of trust and accordingly assigned a different DoS rate limit. The DoS rate limit refers to the number of a particular type of DoS candidate packet (such as packets containing TCP SYN messages) with the same destination address that are allowed to pass through firewall 420 within a particular time period. After reaching the rate limit, any additional packet with the same DoS type and destination address are dropped. For example, packets received from zone 1 over interface 426 are associated with a lowest level of trust since they are received from untrusted sources over public network 12. Accordingly, packets received from zone 1 may be assigned a lower DoS rate limit than other zones.

Zone 2 has a medium level of trust since the packets are supposedly received from a known source 422. Accordingly, zone 2 may be assigned a higher DoS rate limit than zone 1. For example, a larger number TCP SYN packets with the same destination address may be allowed to pass through zone 2 than zone 1 within a defined time period. In this example, zone 3 has a high level of trust, since all packets received on interface 428 are from machines located inside private network 24. Accordingly, the packets received in zone 3 may be assigned an even higher DoS rate limit.

The zones associated with received packets can be identified according to source address or port information. For example, the RSP 100, or some other processing device in the firewall 420, may determine the zones associated with incoming packets based on an associated source address VLAN ID and/or interface that the packet was received over. The firewall 420 then manages DoS attacks in part based on the identified zones associated with the packets. For example, the packets associated with potential DoS threats can be counted, managed, and rate limited according to their associated zones. This allows the firewall 420 to more effectively assign DoS resources to different interfaces according to their associated level of trust. This is explained in further detail below.

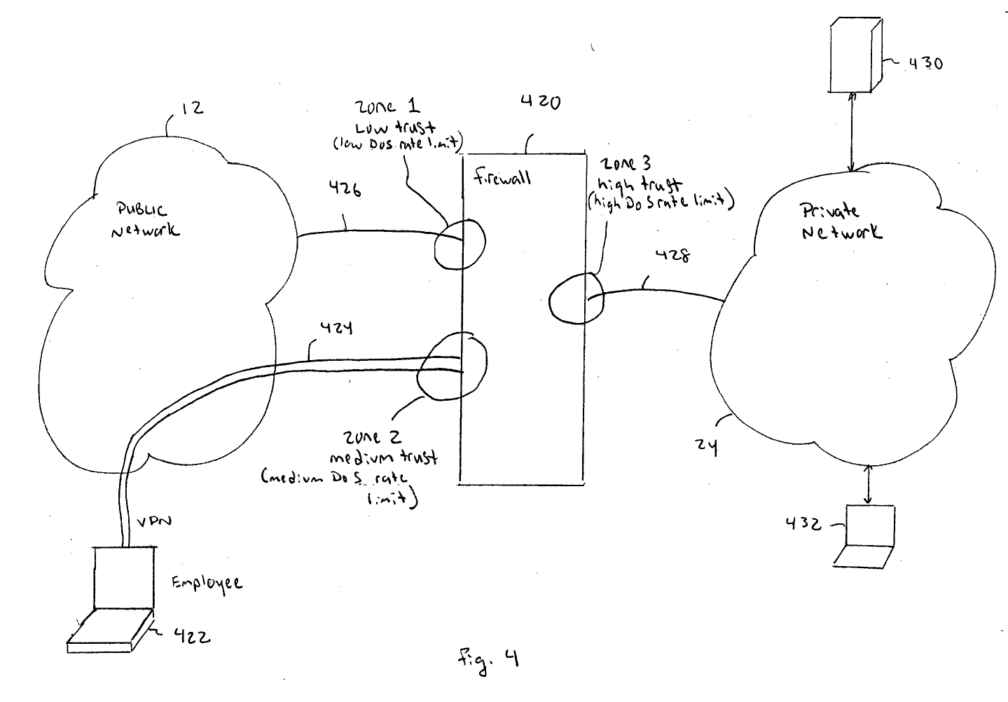

Referring to FIG. 5, one embodiment of the firewall 420 shown in FIG. 4 includes a processor 442 that receives an incoming packet stream 440 that may contain DoS and non-DoS candidate packets. The processor 442 first identifies the packets in packet stream 440 that may be associated with a DoS attack (DoS candidate packets). For example, the processor 442 may identify any incoming packet fragments or packets that contain a TCP SYN message as a DoS candidate packet.

The processor 442 accesses a table 464 to identify the zone 468 associated with the identified DoS candidate packets. For example, the processor 442 may match a port value in the identified DoS packet with a port number entry 466 in table 464. The processor then identifies the zone 468 in table 464 associated with the matching port number entry 466.

The processor 442 uses the combination of the destination address 472 for the identified DoS packet and the associated zone value 468 as an address into a Content Addressable Memory (CAM) 444. The CAM 444 includes DoS entries 445 that are a combination of destination address values and zone values. The address locations in CAM 444 are used as pointers into a Static Random Access Memory (SRAM) 450.

The memory locations in SRAM 450 are partitioned into fields containing a DoS attack flag 452, a time stamp 454, a generation value 456, and an offset 458. The DoS attack flag 452 is set whenever the number of packets for a particular destination address exceeds the predetermined DoS rate limit. As mentioned above, the DoS rate limit can be customized for different zones 448.

The time stamp 454 is set whenever a new entry is added to the TCAM 444 and then reset whenever the age of the time stamp extends beyond a predetermined DoS time period. The generation value 456 is used by the processor 442 for allocating and managing the DoS entries in TCAM 444, SRAM 450 and Dynamic Random Access Memory (DRAM) 462.

The offset value 458 is used as a pointer into the DRAM 462. The DRAM 462 contains a set of counters 460 that track the number of packets for particular destination addresses that are received by the firewall 420 during the DoS time period. The processor 442 identifies new DoS candidate packets 474 that can potentially be part of a DoS attack. The destination address 472 and zone value 468 for the newly identified packet 474 are used as an address into CAM 444. Since a new DoS candidate packet 474 will not match any existing entries, the processor 442 adds a new DoS entry 445 for packet 474 into CAM 444.

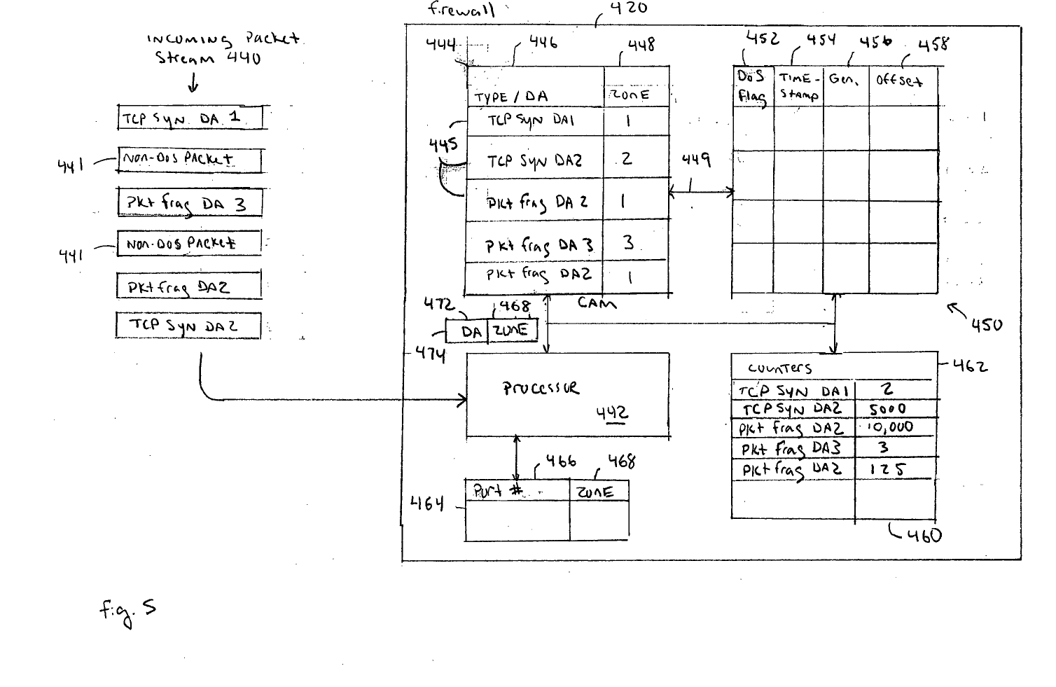

The corresponding DoS attack flag 452 for the new DoS entry in CAM 444 is cleared and the time stamp 454 is set to a current time value. The generation value 456 is set to whatever generation is currently operating in processor 442 as will be described in more detail below in FIG. 6. The processor 442 uses the address offset value 458 to increment a corresponding counter 460 in DRAM 462 to 1. The processor 442 then processes the next packet in the packet stream 440.

Packets in packet stream 440 that do not meet the criteria for a possible DoS attack are not identified as DoS candidate packets 441. For example, the packets 441 may be regular IP packets that are not packet fragments and do not contain a TCP SYN message. In this case, the processor 442 allows the packets 441 to pass through firewall 420 without any further DoS processing.

A next packet in packet stream 440 may be identified as a possible DoS attack (DoS candidate packet). In this example, the next identified packet may already have a corresponding DoS entry in CAM 444. For example, one or more TCP SYN packets or packet fragments with a similar destination address may have been previously received by the firewall 420 within the same DoS time period. Accordingly, the destination address 472 and zone 468 for the packet will match one of the entries in CAM 444. The address 449 corresponding with the matching CAM entry 445 is then used as an address into SRAM 450.

The processor 442 first checks the DoS attack flag 452 in SRAM 450. If the DoS attack flag 452 is set, the processor 442 drops the corresponding packet in packet stream 440. If necessary, the processor 442 may then update the time stamp 454 and generation value 456.

If the DoS attack flag 452 is not set, the processor 442 allows the associated packet in packet stream 440 to pass through the firewall 420. The processor 442 then updates the DoS state information in SRAM 450 and DRAM 462. For example, the processor 442 increments the corresponding counter 460 in DRAM 462 and then compares the time stamp 454 with the current time value. If the time stamp 454 is not too old, the corresponding value for counter 460 in DRAM 462 is valid and compared with the DoS rate limit. If the counter value 460 is below the DoS rate limit, the processor 442 moves on to processing the next packet in packet stream 440.

If the time stamp 454 is too old when compared with a current time value, the corresponding count value 460 in DRAM 460 is stale and reset to zero. The time stamp 454 is also reset to the current time value. This effectively, resets the count 460 during each predetermined time period. If the time stamp 454 is valid (not too old) and the incremented count 460 in DRAM 462 is above the DoS rate limit, the processor 442 sets the corresponding DoS attack flag 452. This causes the processor 442 to drop similar packets having the same destination address.

Generation

The generation value 456 is used for managing DoS entries in CAM 444, SRAM 450 and DRAM 462. Referring to the example in FIG. 6, the CAM 444 is logically divided up into four different generation sections 480. However this is just one implementation and the system can be configured to have any number of generation sections having any configurable size.

The processor 442 in FIG. 5 more efficiently identifies and manages DoS attacks by inserting and removing DoS entries according to generations 480. Referring to FIGS. 5-7, the processor 442 in operation 490 starts entering DoS entries into a current generation 480. This is shown in FIG. 6 where DoS entries 482 are entered into current generation 0. In operation 492, the processor 442 removes one entry 484 from the next generation 1, for every entry 482 added in the current generation 0. This ensures that the CAM 444 will always have available space when the processor 442 moves to the next generation.

The DoS entry 482 may already exist in CAM 444. In this case, the processor 442 in operation 494 switches the currently assigned generation value 456 for the existing DoS entry to the current generation. For example, the DoS entry 482 is received while the processor 442 is operating in generation 0. The DoS entry 482 may match an existing DoS entry 489 currently assigned to generation 2. In operation 494, the processor 442 switches existing DoS entry 489 from generation 2 to generation 0. It should be understood that DoS entry 489 does not physically move to another location in CAM 444 but logically moves to generation 0 when processor 442 reassigns the generation value 456 in SRAM 450 from 2 to 0.

Moving existing DoS entries to a current generation ensures that active DoS entries that may exist in CAM 444 for a relatively long time will not be discarded by the processor 442. For example, a DoS attack may continue for an extended period of time. Each newly received packet for the same DoS attack will update the existing DoS entry in CAM 444 to the current generation value. This ensures that DoS entries representing the active DoS attack will remain in CAM 444 while other older DoS entries that do not mature into DoS attacks, or that no longer represent an active DoS attack, are removed from CAM 444.

In operation 496, the processor 442 determines when a switch should be made to a next generation 480. Different events can cause processor 442 to move to a next generation. The processor 442 may move to a next generation in operation 498 when all entries in the current generation have been filled. This can happen, for example, when an attacker sends many TCP SYN messages with different destination addresses.

The processor 442 will also move to the next generation in operation 498 when a predetermined time period has expired. This ensures that all time stamps 454 (FIG. 5) correspond with a current time period tracked by the processor 442. For example, the time stamps 454 in SRAM 450 in combination with the associated count values in DRAM 462 determine the rate that packets are being received for different destination addresses. After the expiration of the time stamp period, the processor 442 needs to reset both the time stamp value 454 and the associated count value 460.

However, old DoS entries could potentially remain in CAM 444 after a current time value used by the processor 442 rolls-over and resets back to zero. In this case, the processor 442 could mistakenly add count values to a counter 460 in DRAM 460 that corresponds with a previous time stamp period. This could mistakenly cause the counter 460 to count packets over multiple time stamp periods which could lead to mistaken DoS attack detections. In other words, counting packets over multiple time stamp periods gives a false indication of the actual packet rate.

To resolve this potential rollover problem, the processor 442 in operation 496 automatically moves to a next generation after some predetermined time period, regardless of the number of entries in the current generation. This predetermined time period when multiplied by the total number of generations (in this example the total number of generations=4) is less than the rollover time stamp period used by processor 442.

For example, the processor 442 may keep a current timer that rolls-over every 4 seconds. The predetermined time period used for moving to a next generation may be set at 0.5 seconds. This ensures that all stagnant DoS entries in CAM 444 will be removed every 2 seconds. Thus, the processor 442 is ensured that all time stamps 454 in SRAM 450 will be associated with the same time stamp period. This also has the unexpected advantage of allowing the SRAM 450 to use a smaller number of bits for time stamps 454. In other words, the time stamp values 454 only need a sufficient number of bits to track a time period somewhere around 2 or more seconds.

If neither the size limit nor the time stamp period are reached in operation 496, the processor 442 continues to fill up the current generation with new DoS entries and reassign existing DoS entries to the current generation in operations 490-494. If either the size or time stamp limit is reached in operation 496, the processor 442 moves to the next generation in operation 498 and starts adding entries to the new generation. For example, the processor 442 starts moving new DoS entries 486 into generation 1 and according starts removing existing DoS entries 488 from the next generation 2.

Streamlining DoS Attack Identification

Referring briefly back to FIG. 5, when an incoming packet 440 is identified in CAM 444, it may be necessary to increment the associated counter 460 in DRAM 462 to determine if a number of similar packets reach a DoS attack threshold within the time period tracked by time stamp 454. However, the amount of time required to access DRAM 462 may delay a DoS attack determination and the subsequent dropping of the packet. This could also delay the processing of other packets through firewall 420. The DoS attack flag 452 is used by the processor 442 to quickly identify DoS packets that are part of a current DoS attack.

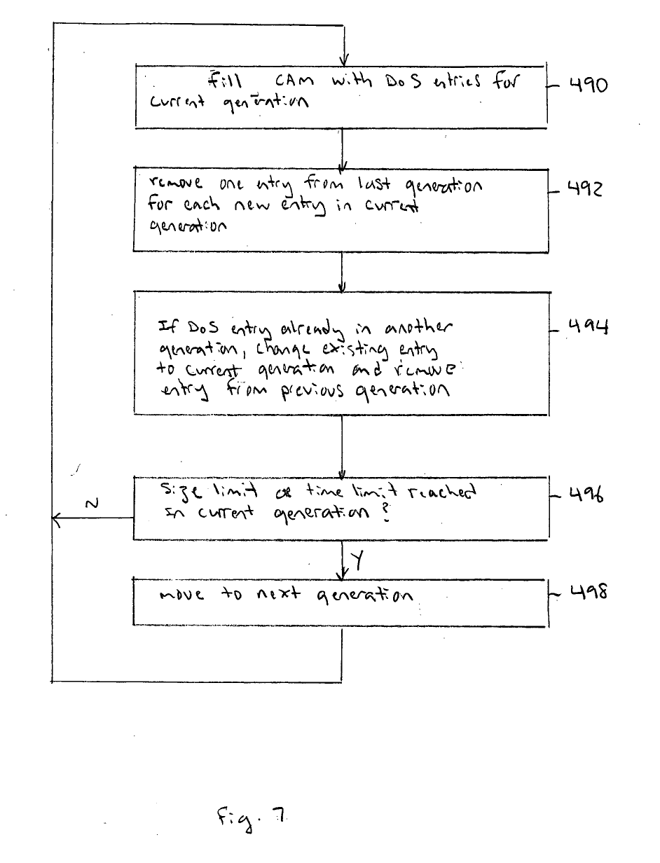

Referring to FIGS. 5 and 8, the DoS attack flag 452 is used in conjunction with other processing operations to reduce the delay required to identify and process DoS attacks. In operation 540, the processor 442 receives packets. In operation 542, the processor 442 determines if the received packet contains a new destination address and zone not currently contained as a DoS entry in CAM 444.

If there is no pre-existing entry in CAM 444, the packet is immediately allowed to pass through the firewall 420. Since the packet is not currently identified in the CAM 444, it cannot be part of a current DoS attack and thus, will not be dropped. After the packet has been allowed to pass, the processor 442, after the fact, conducts DoS maintenance operations. This ensures that other packets following the identified packet are not unnecessarily delayed.

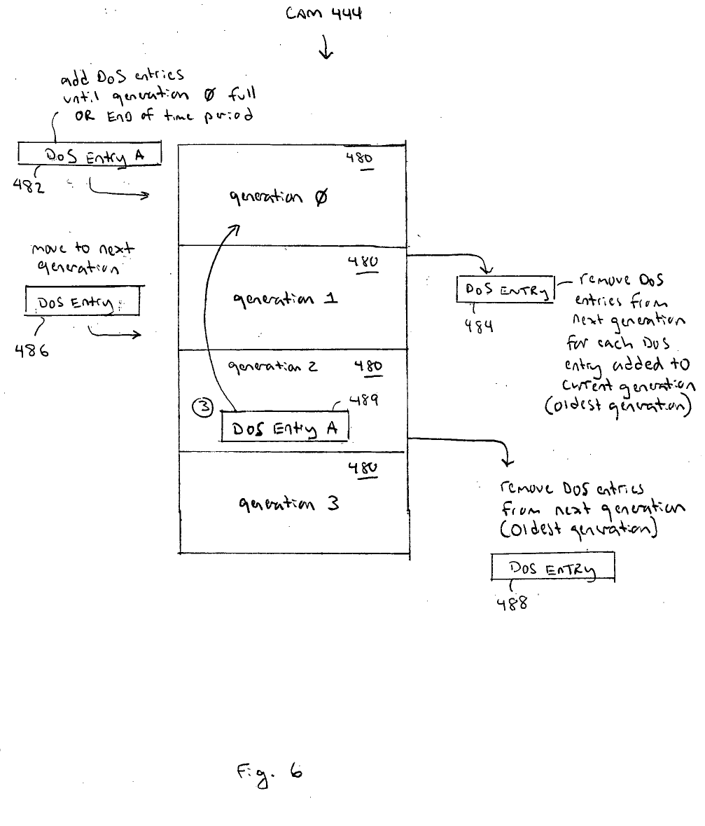

In the “after the fact” maintenance, the processor 442 in operation 546 adds a new DoS entry to the current generation and in operation 548 removes a DoS entry from the next generation as described above in FIGS. 6 and 7. In operation 550, the processor 442 clears the DoS attack flag 452 (if not already cleared), sets a new time stamp value 454, sets the current generation value 456, and increments the corresponding counter 460 in DRAM 462.

If necessary, the processor 442, in operation 552, changes the current generation. For example, as described above, the processor 442 changes the current generation either when all the entries in the current generation are full, or after a predetermined time stamp period has expired. Since the time stamp 454 for the new DoS entry was just set, the time stamp period will not be expired, however, the new DoS entry could have reached the current DoS entry limit for the current generation.

Referring back to operation 542, the processor 442 may receive a packet having a destination address and zone that correspond to an existing DoS entry in CAM 444. The DoS attack flag 452 in SRAM 450 corresponding with the matching CAM entry is immediately read by processor 442 in operation 560. If the corresponding DoS attack flag 452 is set, the packet is immediately dropped in operation 580. The packet may be dropped by not outputting the packet and eventually writing over the packet in memory.

If necessary, the processor 442 in operations 582-586 update information in SRAM 450. However, since the DoS attack flag 452 is already set, the processor 442 does not need to increment the associated counter in DRAM 462. For example, in operation 582, the processor 442 may update the generation value 456 for the DoS entry with the current generation. In operation 584, the processor 442 then determines if the time stamp 454 has expired. For example, when the time difference between a current time stamp value tracked by the processor 442 and the time stamp 454 is greater than some predetermined time period, such as 1 second, the time stamp 454 is reset to the current time stamp value. Accordingly, the associated counter value 460 and DoS attack flag 452 may be cleared in operation 586.

Since the time stamp 454 will only occasionally need to be reset (for example once every second), the count value in DRAM 462 will only occasionally have to be accessed in operation 586. This is particularly important since the DRAM 462 requires a longer access time that SRAM 450. Thus the time required by the processor 442 for DoS maintenance is reduced. Regardless, since the DoS maintenance operations are performed after the packet is already dropped in operation 580, other incoming packets 440 (FIG. 5) will not be unnecessarily delayed by processor 442. This allows the firewall 420 to filter packets at gigabit or faster line rates during a DoS attack without substantially slowing down the processing of other legitimate packets.

In operation 560, a packet may have an existing DoS entry in CAM 444 but the associated DoS attack flag 452 is not set. In operation 562, the packet is allowed to pass through the firewall 420. If necessary, the processor 442 in operation 564 updates the generation information 456 for the matching DoS entry in CAM 444. For example, the existing generation 456 identified in SRAM 450 is set to the current generation. If necessary, the processor 442 in operation 564 may also change the current generation when the generation time period has expired or the maximum number of generation entries in the current generation has reached a predefined limit as previously described in FIGS. 6 and 7.

The counter 460 for the existing DoS entry is incremented in operation 566 and the processor 442 checks the count value 460 and the age of the associated time stamp 454 in operation 568. If the time stamp value is older than the time stamp period (expired time stamp) in operation 570, the count 460 and time stamp 454 are reset in operation 572.

If the time stamp is valid in operation 570, the processor 442 in operation 574 determines if the counter 460 is over the DoS attack threshold. If not, the processor 442 returns to operation 540 and processes the next identified DoS candidate packet for a possible DoS attack. If the counter 460 is over the DoS attack threshold, then the DoS attack flag 452 is set in operation 576.

Note that in one embodiment, the DoS attack flag 452 is set after the associated packet has already passed through the firewall 420. This one additional packet is generally not enough to disturb the operation of the target machine in private network 24 (FIG. 3). However, the ability to forward packets through the firewall 420 without having to wait to complete DoS management operations substantially improves firewall performance. Further, since the operations described above might only be performed for packets associated with possible DoS attacks (DoS candidate packets), the amount of processing required for DoS management and monitoring is substantially reduced from other firewall architectures that process every received packet for a possible DoS attack.

Implementing DoS in RSP

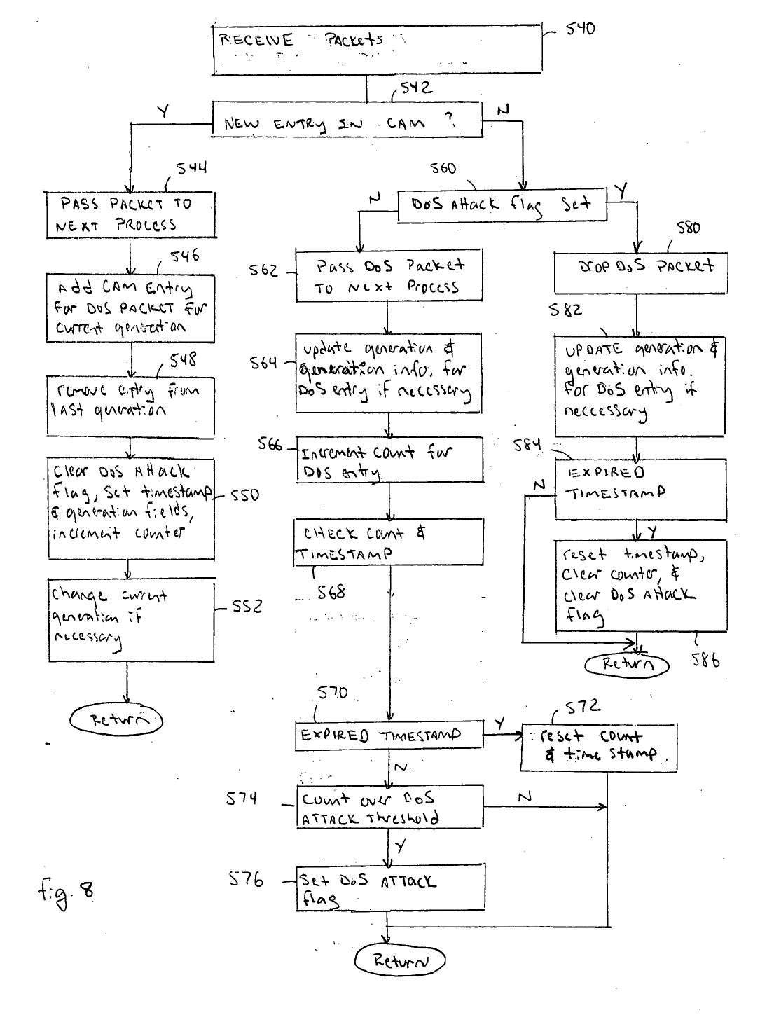

Referring quickly back to FIG. 5, any processor 442 can be used to implement the firewall system described above. However, to further improve performance, the processor 442 in one embodiment is implemented using the Reconfigurable Semantic Processor (RSP) 100 previously described in FIGS. 2A-2C. FIG. 9 shows in more detail how the RSP 100 is used for DoS protection. For simplicity of explanation, some of the processing elements in the RSP 100 previously described in FIGS. 2A-2C are not shown in FIG. 9.

Incoming packets 600 are received in the input buffer 140. The DXP 180 includes grammar in the associated parser table 170 (FIG. 2A) that identifies the packets 600 that may be associated with a possible DoS attack (DoS candidate packets). For example, the parser grammar may identify any incoming packets 600 that contain a TCP SYN message, TCP FIN message, packet fragment, etc. When a DoS candidate packet is identified, the DXP 180 sends a DoS identification message 602 to the SPU 200. The message 602 launches DoS SEP code 620 from the SCT 210 that is executed by the SPUs 200. The DoS SEP code 620 causes the SPUs 200 to perform the different DoS operations described above in FIGS. 3-8.

The memory subsystem 215 includes the DRAM 462, CAM 444, and SRAM 450 previously shown in FIG. 5. An Array Machine-Context Data Memory (AMCD) 230 in one implementation is used for accessing data in DRAM 462 or SRAM 450 through a hashing function or content-addressable memory (CAM) 444.

The AMCD 230 includes a free table 604 that includes bits 605 that are each associated with an entry in CAM 444. Any unused entry in CAM 444 is represented by a zero bit 605 and any valid DoS entry in CAM 444 is represented by an associated one bit 605 in free table 604. The AMCD 320 supports a Find First Zero (FFZ) instruction from the SPUs 200 that identify the first zero bit in free table 604.

When a location in CAM 444 needs to be identified for loading a new DoS entry, the SPUs 200 execute the FFZ instruction on free table 604. The FFZ instruction returns the location of the first zero bit in free table 604 which is then used as a pointer to a corresponding entry in CAM 444. The SPU 200 loads the destination address and zone for the new packet into the address location identified in CAM 444.

As described above in FIG. 6, DoS entries are added to a current generation in CAM 444 and other DoS entries are concurrently removed from a next generation. The SPU 200 uses generation tables 608 to quickly identify which entries in CAM 444 to remove from the next generation. Each generation in CAM 444 has an associated generation table 608A-D. Each valid DoS entry in CAM 444 associated with a particular generation has a corresponding zero bit set in the associated generation table 608. For example, the third entry in CAM 444 contains a DoS entry associated with generation 0. Accordingly, the SPU 200 sets the third bit in generation table 608A to zero.

If DoS entries need to be removed for generation 0, the SPU 200 conducts a FFZ operation on generation table 608A. The third bit in generation table 608A is identified and then used by the SPUs 200 to invalidate the corresponding third DoS entry in CAM 444. For example, the SPU 200 sets the third bit in generation table 608A to one and sets the third bit in free table 604 to zero. Of course this is just one example of how the tables 604 and 608 operate. Other table configurations can also be used.

As described above, these DoS maintenance operations that identify the available entries in CAM 444 and identify which entries to remove from CAM 444 can be done after the SPUs 200 have already dropped or allowed the associated packet to pass through the RSP 100.

The memory subsystem 215 can also include a table 606 that is used by the SPUs 200 to identify the zones previously identified by the policy manager. For example, the packets may include a port number that is identified by DXP 180. The SPU 200 may compare the port number with a packet tag 610A in table 606 to identify the zone 610B receiving the packet. Table 606 can also contain the packet rates 610C associated with each zone to identify DoS attacks. A timer 612 is used by the SPUs 200 to generate the time stamps for each DoS entry in SRAM 450 and to determine when the time stamp period for each time stamp has expired. A generation table 614 identifies the current generation.

The RSP 100 can also identify and discard any packets with bogus IP addresses. For example, a set of IP addresses are reserved as multicast destination addresses. Any packets received with a source address corresponding to the reserved multicast addresses can be detected by the DXP 180 and immediately dropped.

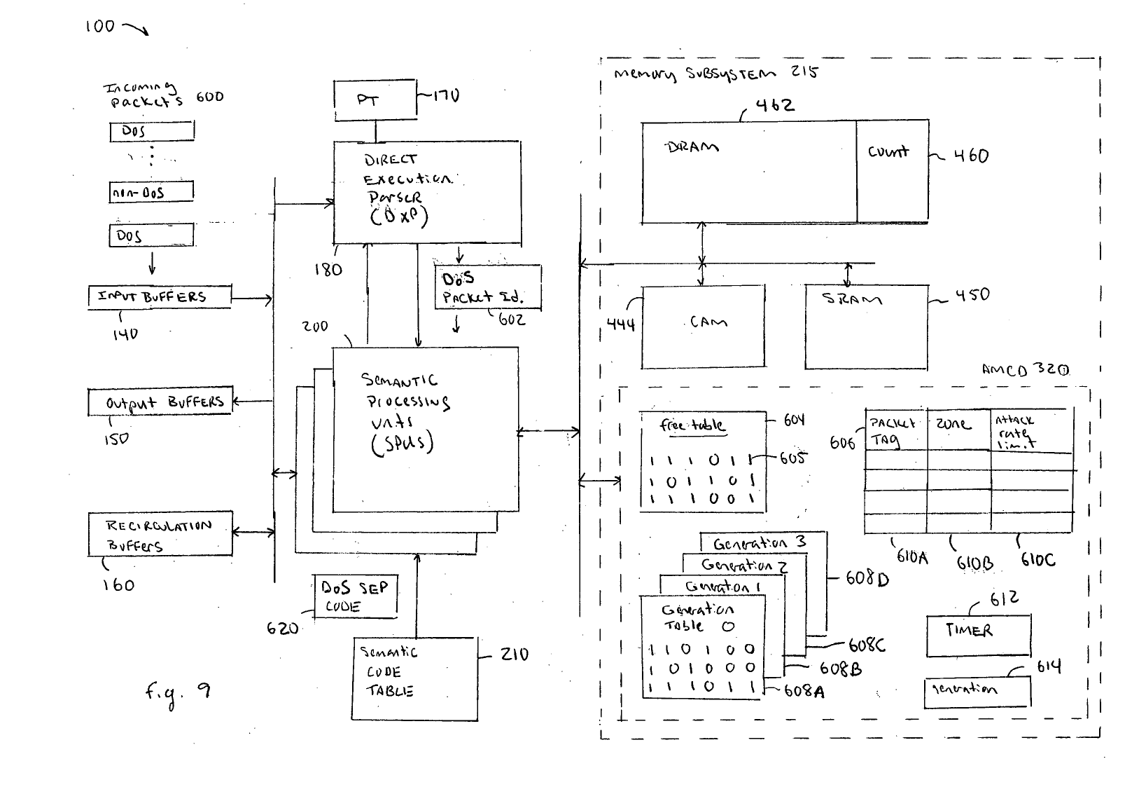

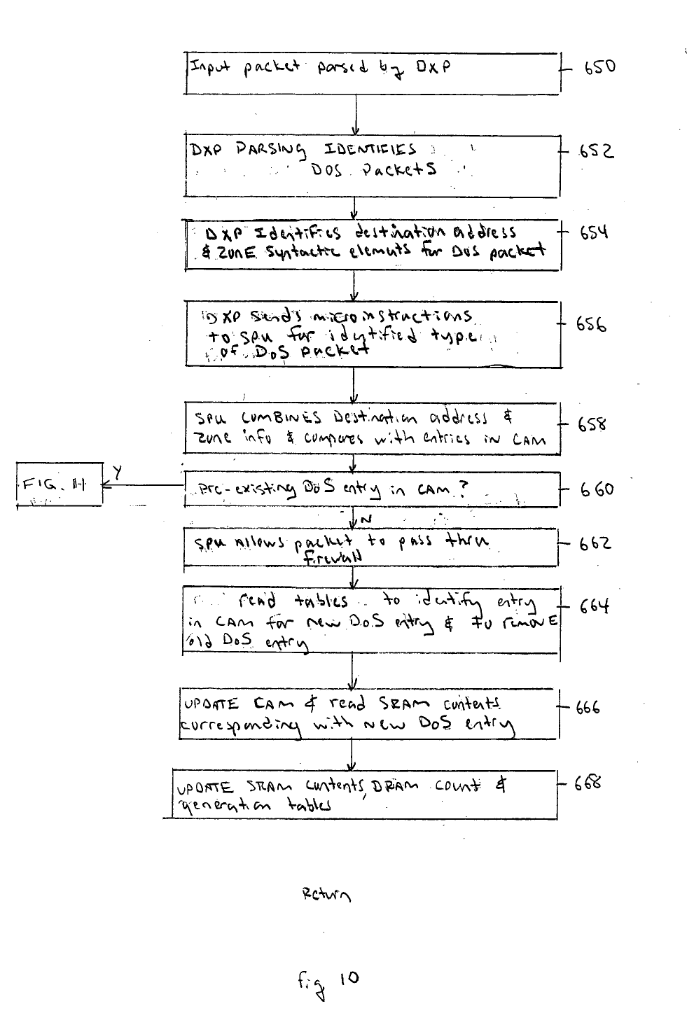

FIGS. 10 and 11 describe at a high level how the RSP 100 implements the DoS operations described above. Referring specifically to FIGS. 10 and 11 and generally to FIG. 9, in operation 650, the DXP 180 parses the incoming packets 600. Grammar in the parsing table 170 is used by the DXP 180 to identify any DoS candidate packets in operation 652. At the same time the DXP 180 may direct the SPUs 200 to store the incoming packet 600 in DRAM 462 or may temporarily keep the packet in input buffer 140. The DXP 180 in operation 654 also identifies the destination address for the packet and the zone where the packet was received.

When a DoS candidate packet is identified, the DXP 180 in operation 656 sends signaling 602 to the SPUs 200 to load DoS SEP code 620 associated with the required DoS operation. For example, the SEP code 620 may be associated with a specific type of DoS operation associated with an identified TCP SYN packet or identified packet fragment.

The SPU in operation 658 compares the identified destination address and associated zone information with entries in CAM 444. If a corresponding DoS entry exists in CAM 444 in operation 660, the SPU 200 conducts the DoS operations described in FIG. 11 below. If no DoS entry currently exists in CAM 444, the SPU 200 in operation 662 allows the packet to pass through the firewall. This may simply mean the SPU 200 continues any other required firewall processing on the corresponding packet in DRAM 462 before sending the packet to output buffer 150. Or if not already stored in DRAM 462, the SPU 200 may allow the packet in input buffer 140 to be stored in DRAM 462 for further processing.

The SPU 200 then performs any necessary DoS maintenance. For example, in operation 664, the SPU 200 reads table 614 in AMCD 320 to determine what generation is currently active for the associated DoS operation. The SPU 200 also reads tables 604 and 608 to determine where to add the new DoS entry in CAM 444 and which DoS entry to drop from the next generation. In operation 666, the SPU 200 updates the CAM 444 with the new DoS entry and reads the contents of the corresponding memory location in SRAM 450. Finally, in operation 668, the SPU 200 updates the time stamp and generation information in SRAM 450 and the count information in DRAM 462.

Referring to FIG. 11, when the destination address and zone for the packet are already DoS entries in CAM 444, the SPU 200 in operation 700 reads the corresponding memory location in SRAM 450. The SPU 200 in operation 702 checks to see of the DoS attack flag is set. If the DoS attack flag is set, the SPU in operation 704 immediately drops the packet from DRAM 462 or from input buffer 140. For example, the SPU 200 may set a drop flag in DRAM 462 that indicates the packet is invalid.

The invalid packet is then never read out of DRAM 462 and eventually overwritten with other data. In not yet stored in DRAM 462, the packet is dropped from input buffer 140. If the DoS attack flag is not set, the SPU in operation 706 immediately releases the packet for further processing. For example, the packet may be immediately transferred from input buffer 140 to a particular location in DRAM 462. If already in DRAM 462, the packet may be passed off to another SPU 200 for further firewall processing or sent to output buffer 150 if no further firewall processing is required. Alternatively, the SPU 200 may send the packet from DRAM 462 to recirculation buffer 160 for reparsing by DXP 180. For example, the DXP 180 may then identify other contents in the packet associated with other firewall operations.

In operation 708, the SPU 200 updates the information in SRAM 450 and if necessary, increments the associated count 460 in DRAM 462. The SPU 200 in operation 710 then updates any necessary information in tables 604, 606, 608 and 614. The SPU 200 then waits for new SEP instructions 602 from the DXP 180.

### Unified Firewall/Routing Management (Unified Policy Management)

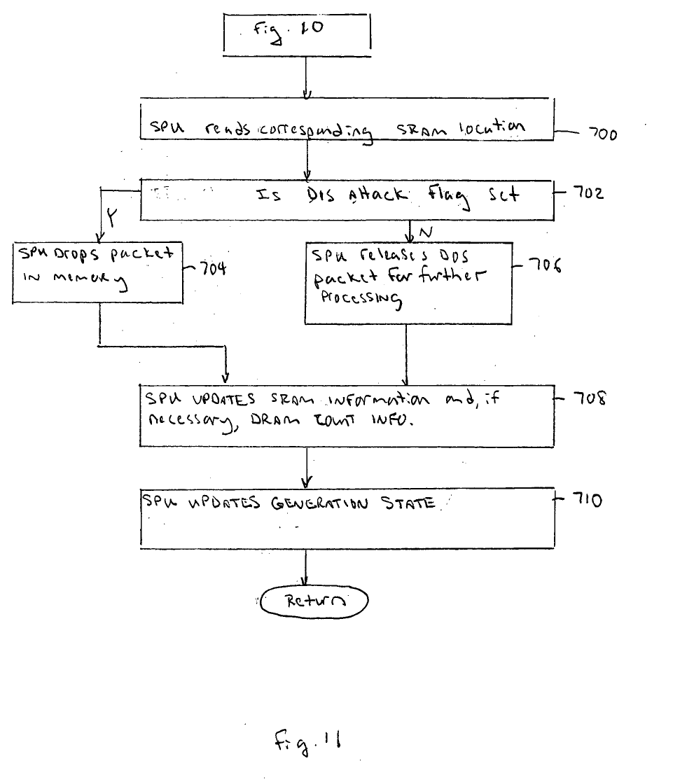

Referring to FIG. 12, a firewall 804 operates between a first network 800 and a second network 812. The firewall 804 provides a variety of network interface operations. For example, in addition to identifying and filtering DoS attacks as described above, the firewall may need to convert packets between different network formats, such as between IP version 4 (IPv4) and IP version 6 (IPv6), or converting between public and private IP addresses (Network Address Translation (NAT)). The firewall 804 may also be required to perform other virus detection and security operations.

Another separate network computing device 806, such as a router or switch, is then required to route or switch the packets that pass through the firewall 804. For example, the packets received from router/switch 806 may be forwarded to other routers or switches 808 that then further forward the packets to other network processing devices in network 812. The router or switch 806 may also route the packets to endpoints, such as a server 810 or personal computer (PC) 814.

The problem with this conventional architecture is that the firewall device 804 and routing device 806 operate autonomously. Therefore, separate processing and memory resources are required for each device 802 and 806. This not only increases the hardware costs of the edge equipment but also limits scalability and may prevent these edge devices from processing packets at required line rates.

For example, the firewall 804 may be required to monitor every incoming packet for possible TCP SYN packets. As described above, this may require the firewall 804 to identify the destination address for each incoming packet. The TCP SYN packets that are not part of a DoS attack are then forwarded to the router 806. The router 806 then again has to determine the destination addresses for the packets 805 received from the firewall 804 in order to route the packets to the proper destination. Thus, each network processing device 804 and 806 is required to do some of the same packet processing operations on the same packets. As a result, each device 804 and 806 must maintain separate packet states, packet buffers, etc. This as mentioned above, limits the overall scalability and processing capacity for network processing devices.

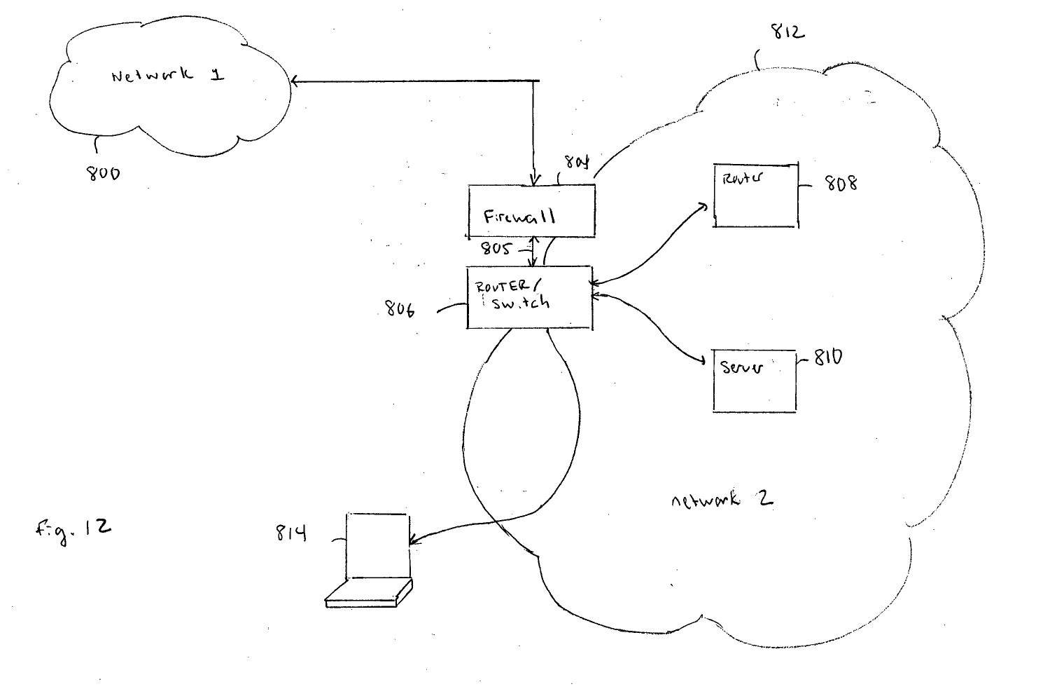

Referring to FIG. 13, another aspect of the invention uses Unified Policy Management (UPM) in a network processing device 820 to more efficiently process packets. In one example, UPM integrates conventional firewall and edge device operations with packet forwarding operations that until now were conventionally performed by separate independently operating processors. In one implementation, a unique Access Control List (ACL) table is used by a processor 822 to provide a variety of different UPM operations.

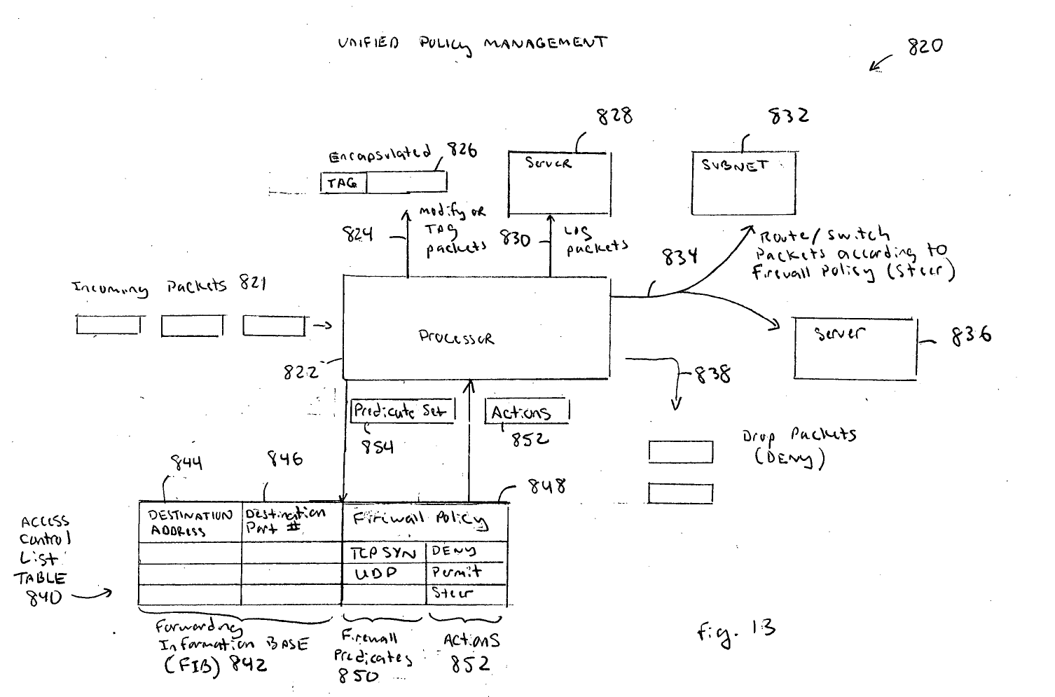

The processor 822 receives an incoming packet stream 802 and identifies a predicate set 854 associated with the individual packets 821. The predicate set 854 is described in more detail in FIG. 14 below but generally can be any information in the received packets that may be relevant to a firewall or forwarding operation. For example, the predicate set 854 may include, but is not limited to, IP addresses, TCP port numbers, IP protocol identifiers, etc. The predicate set 854 in another unique aspect of the invention may also include higher Open System Interconnect (OSI) layer information, such as Session Initiation Protocol (SIP), Universal Resource Locator (URL), Simple Messaging Transport Protocol (SMTP), Hyper-Text Transfer Protocol (HTTP), File Transfer Protocol (FTP) information as well as other application layer information, such identification of attachments and other text documents.

The Access Control List (ACL) table 840 is organized according to the different combinations of predicate entries 850 that may be associated with different UPM or other firewall operations. For example, a first set of firewall policy ACLs 848 may be associated with different Denial of Service (DoS) operations that determine weather or not incoming packets 821 are allowed to pass through network processing device 820. The firewall policy ACLs 848 may also be associated with other packet conversion, authentication, and filtering operations that may need to be performed by the network processing device 820, such as Network Address Translation (NAT), virus detecting and filtering, IP version translation, etc.

In another particularly unique implementation, the ACL table 840 may also include a Forward Information Base (FIB) 842 that associates different destination addresses 844 with different destination port numbers 846. The FIB 842 may reside in a separate section of the ACL table 840 and/or may be integrated with some of the firewall policy ACLs 848 as will be described in more detail below.

The ACL entries in table 840 also include actions 852 that direct the processor 822 to either permit or deny the associated packet from passing through network processing device 820. Other ACL actions 852 may steer the associated packet to a particular destination or back through the processor 822 for additional processing. In another situation, the firewall policy action 852 may direct the processor 822 to route the associated packet 821 to a particular output port 846.

The combination of the firewall policy ACLs 848 and the FIB 842 in table 840 provide a variety of different UMP operations that are not typically performed in the same network processing device 820. For example, a small subset of UPM operations include dropping packets 838 as described above for DoS or for intrusion detection. The network processing device 820 can also modify or tag packets 824 before being forwarded toward a destination address. For example, the packets 824 may be encapsulated in a particular tunnel 826 or tagged with a particular QoS level, etc.

In another UPM action, entries in ACL table 840 may direct the processor 822 to log statistics for any passed or dropped packets 830 to a server 828. In another UPM operation, as briefly mentioned above, entries in ACL table 840 may cause processor 822 to forward packets 834 to different sub-networks 832 or devices 836 according to different firewall policy metrics. For example, packets 834 containing a particular HTTP session may be routed to server 836 while all other packets may be routed to subnet 832.

In the description above in FIG. 13 and in the further description below, routing and switching are used interchangeably. Those with average skill in the art would appreciate that the UPM system 820 can conduct unified layer-two switching and/or layer-three routing operations in combination with other firewall policy metrics as will be described in further detail below.

Access Control List

FIG. 14 shows example entries in the ACL table 840 described above in FIG. 13. Any combination of predicates and actions can be combined together in ACL table 840 and FIG. 14 shows only a few examples. In one embodiment, the processor 822 (FIG. 13) concatenates one or more ACL predicates together and uses the combined predicate set 854 as an address entry into a CAM that contains the ACL table 840. The action associated with the action for the first entry in ACL table 840 that matches the predicate set 854 submitted by processor 822 is output by the CAM.

A first entry 860 in ACL table 840 includes a destination IP address predicate 860A, source IP address predicate 860B, TCP port number predicate 860C, established TCP session predicate 860D, and a permit action 860E. In this example, ACL 860 is the first entry in ACL table 840. Of course, any sequence and combination of ACL entries can be loaded into the ACL table 840.

The associated action 860E is output from ACL table 840 when the predicate set 854 supplied by processor 822 matches predicates 860A-860D. In this example, the ACL table 840 outputs the permit action 860E when the destination IP address and the source IP address for an incoming packet 821 (FIG. 13) match the values in predicates 860A and 860B, respectively. The IP addresses identified in predicates 860A and 860B may only include the subnet addresses associated with the complete IP source and destination addresses. The additional bits in the IP address may be masked out as “don't care” values similar to the way subnet masks are currently used in routing tables.

In order to match ACL entry 860, the packet 821 (FIG. 13) must also have an associated TCP port number corresponding with predicate 860C. Notice that no source or destination qualifier is associated with the TCP port number predicate 860C. This means that either a same source TCP port number C or a same destination TCP port number C in the packet 821 will match predicate 860C. Finally, in order to match ACL entry 860, the incoming packet 821 must be part of an already established TCP session as required by established TCP predicate 860D. Predicate 860D can simply be a flag in the predicate set 854 that is set by the processor 822 when the incoming packet 821 is determined to be part of an already established TCP session. The ACL entry 860 would therefore not match a packet containing a TCP SYN message attempting to establish a new TCP session.

The next two ACL entries 862 and 864 are associated with firewall policies relating to Denial of Service (DoS) attacks. In order to match ACL entry 862, the address in incoming packet 821 must match the destination and source IP address predicates 862A and 862B, respectively. In addition, the incoming packet 821 must also be a TCP packet as required by the type TCP predicate 862C. The ACL entry 862 associates the particular destination and source IP addresses for a TCP packet with a TCP DoS action 862D corresponding with a particular zone as previously described above in FIG. 4. Accordingly, the action 862D may direct the processor 822 to conduct the DoS operations described above in FIGS. 4-11 using a particular packet rate threshold corresponding with zone 1.

The ACL entry 864 is associated with a TCP DoS action 864D and includes the same destination IP address predicate 864A as destination IP address predicate 862A. However, the predicate 864B contains a different source IP address C than source IP address predicate 862B. This corresponds with packets that may be received from a different network interface. Accordingly, the ACL action 864D is for a TCP DoS operation with a different corresponding zone 3. The processor 822 upon receiving action 864D may use a different packet rate threshold for determining DoS attacks.

The ACL entry 866 is associated with an Internet Protocol version 4 (IPv4) to Internet Protocol version 6 (IPv6) translation. For example, the incoming packets 821 may be received over a network that operates using IPv6. However, the network operating on the other side of network processing device 820 may use IPv4. Accordingly, the network processing device 820 may need to translate all IPv6 packets into IPv4 packets.

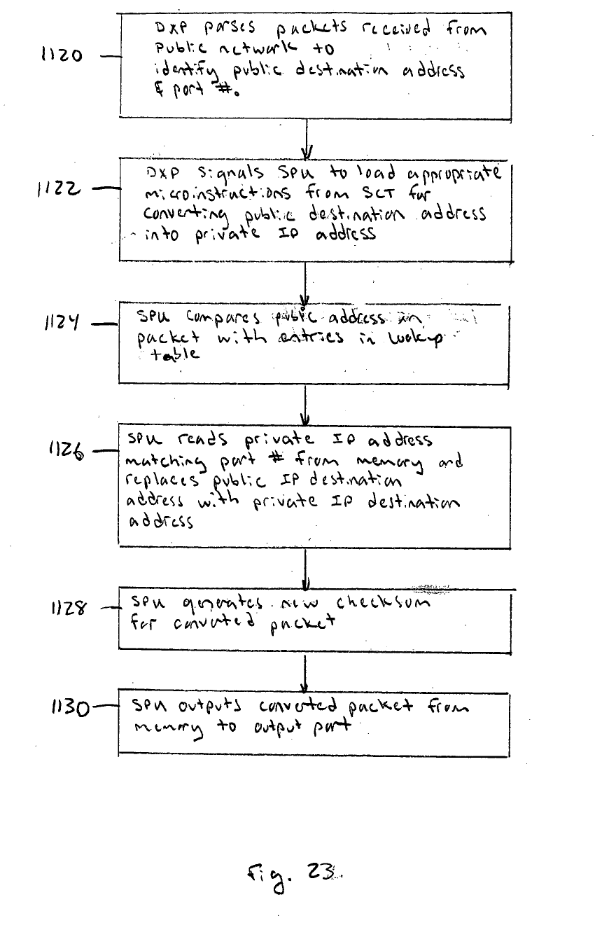

An IP type field in the IP header of the incoming packet 821 identifies the packet as either IPv4 or IPv6. The processor 822 extracts the destination IP address and IP version identifier in the IP type field from packet 821 and formats the information into a predicate set 854 that is applied to ACL table 840. When the predicate set 854 matches the predicates 866A and 866B in ACL entry 866, the processor 822 receives back the XLATE IPv6 action 866C. The XLATE action 866C directs the processor 822 to translate the incoming IPv6 packet 821 to IPv4 using a particular rule 5. For example IPv6-Rule 5 may direct the processor 822 to encapsulate the IPv6 packet in an IPv4 header or split portions of the IPv6 address into different company and host codes contained in a IPv4 header. The translation between IPv6 and IPv4 is described in further detail below in FIG. 24.

The ACL entries 868 and 870 are associated with policy based routing or switching operations. The ACL entry 868 includes Forwarding Information Base (FIB) routing criteria 868A and 868C that is combined with firewall policy metric 868B. Similarly, the ACL entry 870 includes FIB routing criteria 870A and 870C that is combined with firewall policy metric 870B. These ACL entries 868 and 870 allows the network processing device 820 to route or switch packets to different ports based both on IP destination addresses and firewall policy metrics.

For example, ACL entry 868 contains a forwarding action 868C that directs the processor 822 to output an incoming packet 821 to port 3 for TCP packet types 868B having a destination IP address G. However, ACL entry 870 directs the processor 822 to forward UDP packet types 870B with a same destination IP address G to a different output port 4. These policy based routing ACLs may be used for example to route TCP bus threats to a particular processing device for further DoS processing, while UDP packets are routed toward the destination address corresponding to predicate 870A. The entries in ACL table 840 of course are only a small sample of the different ACLs that can be used to conduct unified policy management.

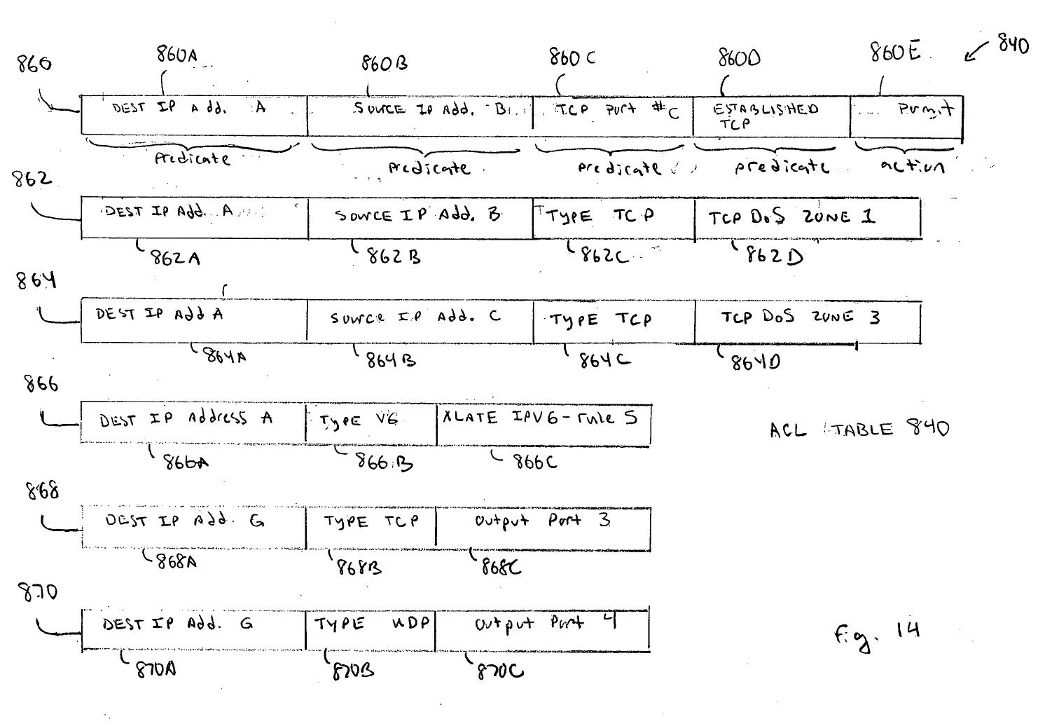

FIG. 15 describes in more detail how the network processing device 820 in FIG. 13 conducts UPM. In operation 880, the processor 822 receives incoming packets 821 and in operation 882 generates a predicate set 854 from the incoming packets. For example, the processor 822 may be programmed to identify, extract, and format a predefined set of IP packet fields into predicates in a predetermined order. If one of the IP packet fields does not exit in an incoming packet 821, the next packet field in the list is extracted and combined with the previously extracted and formatted predicates.

The processor 822 in operation 884 applies the predicate set 854 to the ACL table 840 and in operation 886 receives and executes the action received back from the matching predicate entry in ACL table 840. For simplicity, only three action categories are described in FIG. 15 coming back from the ACL table. However, any number of different actions can be configured into the ACL entries. If a drop action 852 is received back from the ACL table 840 in operation 892, the processor discards the packet in operation 900. The processor 822 may log any statistical information related to the dropped packet in operation 902 before beginning processing on a next incoming packet 821.

If a pass action 852 is received back from the ACL table in operation 890, the processor in operation 898 may route or switch the packet according to the FIB 842 (FIG. 13). The pass action 890 may contain the forwarding port number or may direct the processor 822 to re-access ACL table 840 to obtain the forwarding port information.

If a steer ACL action 852 is received back from the ACL table in operation 888, the processor in operation 894 conducts the firewall operation associated with the ACL action. If applicable, the processor 822 may also forward the packet in operation 894 according to an associated firewall policy metric. For example, as described above in FIG. 14, the steer action 852 may direct the processor to forward TCP packets out over a particular port toward a network processing device that checks for DoS attacks.

Alternatively, the steer action 852 identified in operation 888 may direct the processor 822 to conduct additional firewall processing on the packet. For example, the steer action 852 may also direct the processor 822 to conduct Network Address Translation (NAT). Accordingly, the processor 822 may extract another predicate set 854 in operation 882, if necessary, from the packet 821 and reapply the new predicate set 854 to the ACL table 840 in operation 884. According to the next ACL action 852 received back from the ACL table 840, the processor 822 may drop, pass or steer the packet after the NAT operation.

Forwarding Packets According to Upper OSI Layers

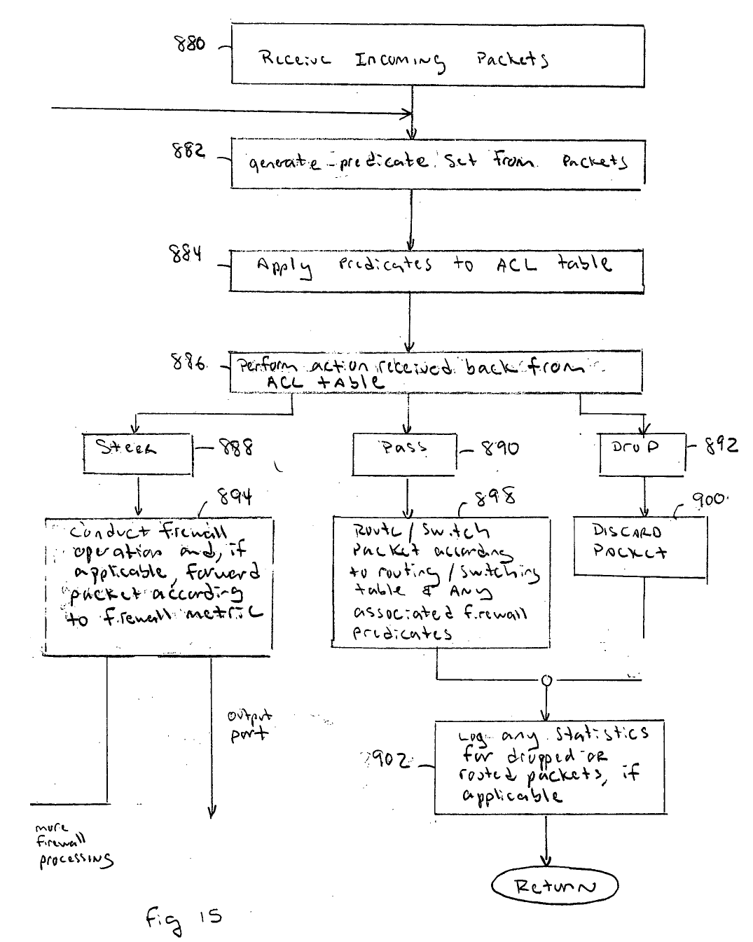

FIG. 16 describes another example of how routing and switching operations are integrated with firewall policy management. An ACL table 910 is similar to ACL table 840 in FIG. 13. However, ACL table 910 combined the Forwarding Information Base (FIB) with layer 4 and layer 7 policy metrics 910D and 910E, respectively.

An important aspect to note is that any combination of policy management metrics can be added to conventional routing and switching forwarding tables simply by adding new predicates to table 910. Another important characteristic to note is that routing or switching decisions are conventionally limited to layer 2 and layer 3 of the Open System Interconnect (OSI) internet model. For example, a switch or router typically makes packet forwarding decisions based on packet port numbers and IP addresses.

The ACL table 910 in combination with the network processing device architecture in FIG. 13 enable forwarding decisions to be based on information contained in higher OSI layers. For example, some packet forwarding decisions in ACL table 910 are based on information in the data link (layer 2), network layer (layer 3), transport layer (layer 4) and application layer (layer 7). Of course, forwarding decisions can also be based on any of the other OSI layers.

To explain in further detail, the ACL table 910 includes destination IP address predicates 910A that are used in part to forward packets to different output ports identified in actions 910C. Conventional subnet masks in predicates 910B are used for masking bits in the destination IP address predicates 910A. For example, in the first ACL entry 912, only the first three subnet fields of the address “10.0.0” are compared to the destination IP address for the incoming packets 821. In ACL entry 916, only the first subnet fields “10” is compared with the destination IP address for the incoming packets 821.

In this example, the forwarding decisions are based on the destination IP address 910A in addition to layer 4 or layer 7 predicates 910D and 910E, respectively. For example, an incoming TCP packet with the destination IP address “10.0.0.x” (where “x” represents a “don't care”) will be routed to output port 15. Alternatively, an incoming UDP packet with the destination IP address “10.0.0.x” will be routed to output port 5.

The TCP and UDP identifiers for the incoming packet 821 are identified by the processor 822 during initial packet processing at the same time the processor 822 identifies the destination IP address. The destination IP address, and TCP or UDP identifier, are then compared to the entries in ACL table 910 to determine the correct output port for forwarding the packet. This shows one example, of how packets are forwarded based on layer 4 metrics.

The ACL entry 914 is a conventional forwarding table entry that forwards packets to a particular output port 2 when the input packet contains the subnet fields “12.0.x.x” in the destination IP address.

The ACL entry 916 bases routing decisions according to both a destination IP address and a layer 7 Session Initiation Protocol (SIP) metric. For example, a non-SIP packet with the IP destination address “10.x.x.x” is routed to output port 7 in network processing device 820. However, a SIP packet with the IP destination address “10.x.x.x” is routed to output port 4. This is useful for packets containing Voice Over IP (VoIP) SIP signaling that need to be routed to a specific network processing device, such as a SIP proxy server. Other non-SIP IP traffic is routed in a conventional manner according to the destination address. The SIP identifier used for comparing to SIP predicate 910E in ACL entry 916 is a flag generated by the processor 822 when the packet contains SIP messaging.

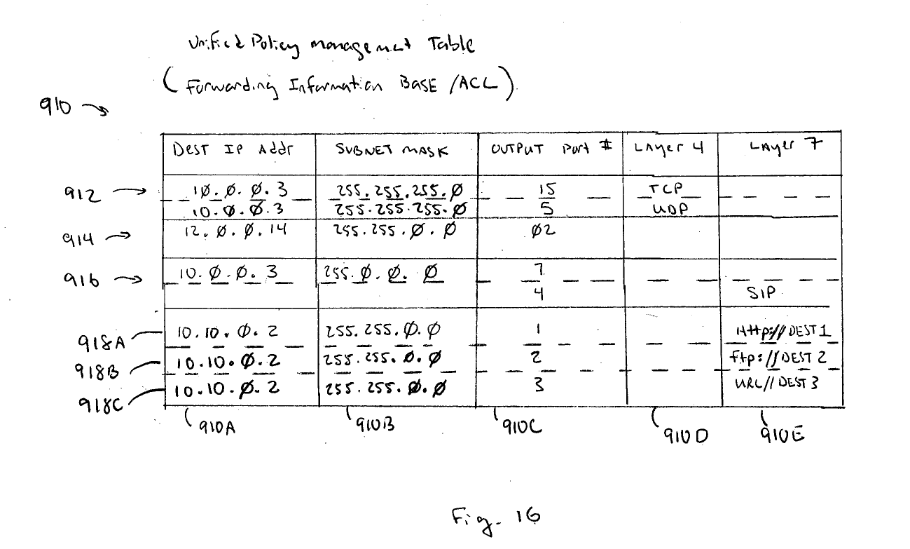

The ACL entry 918 shows another example where routing is based on layer 7 URL metrics. One application for this sort of routing may be used for accessing web servers and then more efficiently routing subsequent URL packets to different locations. Referring both to FIGS. 16 and 17, an enterprise may operate a web server 934 that is accessible by different users 930 over the Internet 932. The web server 934 may display a web page 936 to the user 930 that provides multiple different links to different business services. For example, a first URL link 938 may direct the user to customer support, a second URL link 940 may direct the user to automobile sales, and a third link 942 may direct the user 930 to furniture sales.

The web servers that support each of these different links 938, 940, and 942 may be located in different Internet locations and possibly, but not limited to, different geographical locations. For example, a customer support server 944 may be located in corporate headquarters in Atlanta, an automobile sales server 946 located in Detroit, and a furniture sales server 949 located in Paris, France. The ACL table 910 (FIG. 16) is used to more efficiently connect user 930 to the URL links 938, 940, and 942.

For example, when the user clicks on the customer support link 938, the web server 934 generates packets having the destination IP address “10.10.x.x” that contains the URL “Http://DEST1”. The router 935 in FIG. 17 compares both the IP destination address and URL with the entries in ACL table 910. Accordingly, the router 935 routes the packets to the customer support server 944 over output port 1. The router 935 may also receive packets with the same destination IP address “10.10.x.x” but with URL “fttp:/DEST2”. The router 935 accordingly routes these packets through port 2 to the automobile server 946. Packets with destination IP address “10.10.x.x” and associated URL/DEST3 are routed to the furniture server 948 over port 3. This provides more direct routing to the desired IP destination.

Unified Policy Management Using RSP

As described above, Unified Policy Management (UPM) can be implemented in a conventional processor and computing system architecture as shown in FIG. 13. However, to further performance, UPM may be implemented in a Reconfigurable Semantic Processor (RSP) similar to RSP 100 previously shown in FIGS. 2A-2C.

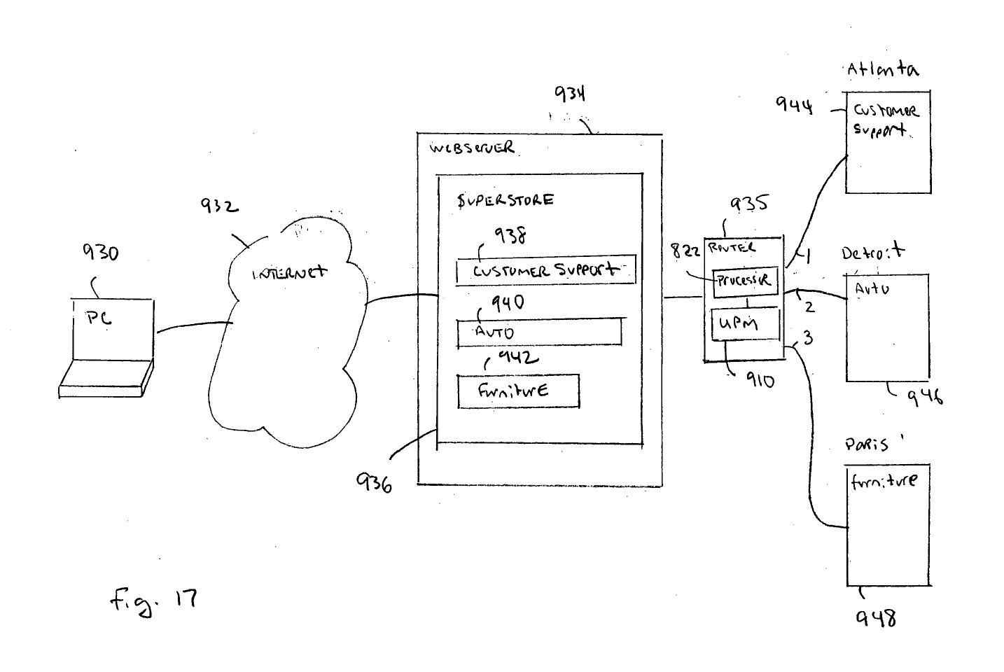

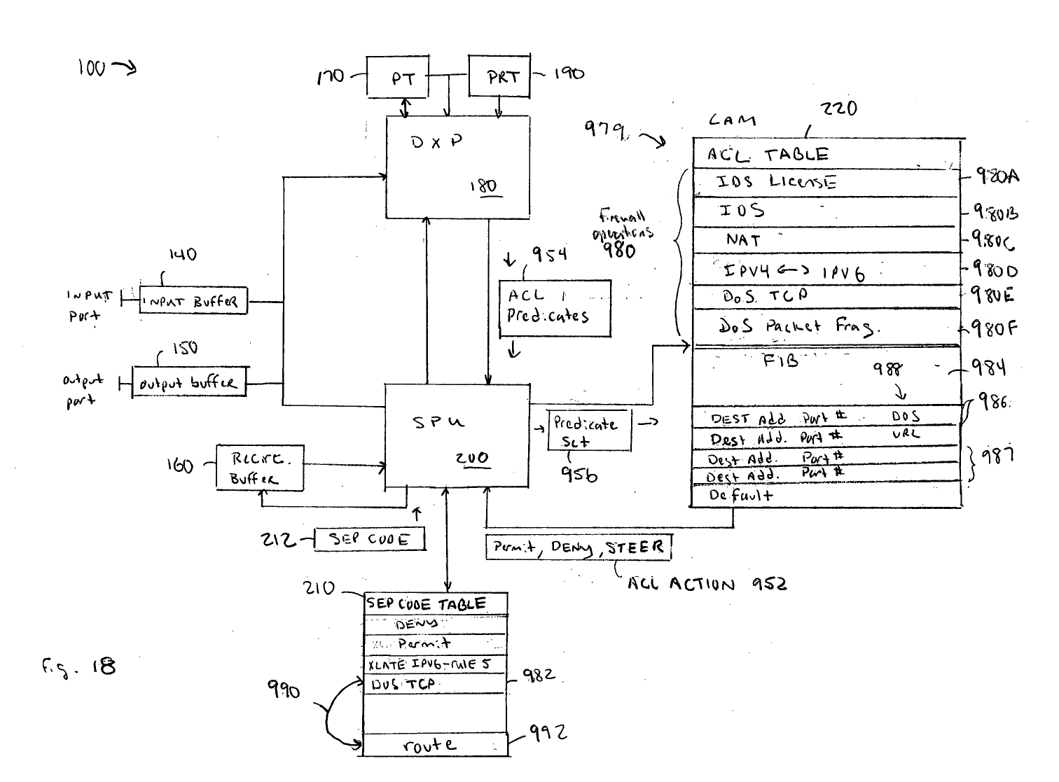

Referring to FIGS. 18 and 19, in operation 1000 the DXP 180 in RSP 100 executes grammar that parses the packets in input buffer 140 and identifies any ACL predicates 954 required for conducting UPM operations. The DXP 180 in operation 1002 sends instructions to the SPU 200 that launches SEP code 212. The SEP code 212 causes the SPU 200 to format the ACL predicates 954 into a predicate set 956 that is then applied to the ACL table 979. In this example, some or all of the ACL table 979 is contained in one or more CAMs 220.

Any number of ACL predicates 954 can be combined by the SPU 200 into ACL predicate set 956 depending on the grammar executed in the DXP 180 and the associated SEP code 212 launched by the DXP 180. For example, the grammar in DXP 180 may identify ACL predicates 954 for the packet destination and source address. Other predicates 954 may be identified for IPv6-IPv4 translation or for TCP DoS operations. The SEP code 212 launched by the DXP 180 may cause the SPU 200 to combine a destination IP address predicate with a IPv6 packet type predicate when the DXP identifies a IPv6 packet. Similarly, when a TCP packet is identified, the DXP 180 may launch SEP code 212 that causes the SPU 200 to combine the destination IP address predicate 954 with a TCP packet type predicate 954 in predicate set 956.

In operation 1004, the SPU 200 applies the ACL predicate set 956 to the ACL table 979 in CAM 220. The SPU in operation 1006, then processes the packet according to the ACL action 952 received back from the CAM 220. In operation 1010, the ACL action 252 may be a simple drop instruction that causes the SPU 200 to discard the packet currently stored in DRAM 280 (FIG. 2A). In operation 1012, the ACL action 952 may be an instruction that causes the SPU 200 to send the packet in DRAM 280 out to the output buffer 150.

In a third situation, the ACL action 952 may cause the SPU 200 to launch addition SEP code 212 that may be associated with a particular firewall operation. For example, a set of ACL entries 980 may be associated with different firewall operations. An ACL entry 980A may be associated with an Intrusion Detection System (IDS) license operation that is described in more detail below. Another ACL entry 980B may be associated with a corresponding IDS operation described in co-pending application entitled: METHOD AND APPARATUS FOR INTRUSION DETECTION IN A NETWORK PROCESSING DEVICE, filed May 9^{th}, 2005, Ser. No. 11/125,956 which has already been incorporated by reference.

Other ACL entries 980C-F may be associated with other firewall operations such as Network Address Translation (NAT), IPv4-IPv6 translation, Denial of Service (DoS) for TCP sessions, and DoS for packet fragments, as already described above, or as will be described in more detail below.

For example, the SPU 200 may apply an ACL predicate set 956 to the CAM 220 that matches ACL entry 880E corresponding with a DoS TCP packet. The action contained in ACL entry 980E may be a pointer 982 into semantic code table 210. The SPU 200 in operation 1008 in FIG. 19 launches and executes the SEP code at pointer location 982. In this example, the SEP code 212 at location 982 causes the SPU 200 to conduct some or all of the TCP DoS operations described above in FIGS. 4-11.

After completing the TCP DoS operations launched by the action in ACL entry 980E, the SEP code 212 may cause the SPU 200 to do any of a variety of other firewall operations. For example, as represented by path 1014, the SPU 200 may be directed to assemble another ACL predicate set 956 from the ACL predicates 954 identified by the DXP 180. The new predicate set 956 is then reapplied to the ACL table 979 for conducting other firewall operations. The SEP code 212 may direct the SPU 200 to drop the packet as represented by path 1016 in FIG. 19 or send the packet to the output port as represented by path 1018.

As previously described above in FIGS. 13-17, the RSP 100 can also conduct Unified Policy Management that unifies both routing/switching operations with other firewall policy management operations. Accordingly, the CAM 220 may also include a forwarding information base 984 that includes entries having destination IP addresses and associated destination port numbers. As shown above in FIG. 16, the FIB table 984 may have conventional FIB entries 987 and other entries 986 that route packets according to both a destination address and other firewall policy metrics 988.

The RSP 100 can easily move between operating as a firewall, conventional router or switch, or a combination of both. For example, path 990 in semantic code table 210 (FIG. 18) represents the RSP 100 switching from a DoS TCP operation to a routing operation. A first predicate set 956 submitted by the SPU 200 to the CAM 220 may match the DoS TCP entry 980E. After completing execution of SEP code 982 associated with the DoS TCP operation, the SPU 200 may be directed to submit another predicate set 956 to the CAM 220. The new predicate set 956 may match an entry 986 or 987 in the FIB 984. The entry in FIB 984 may direct the SPU 200 to SEP code 992 in SCT 210 that conducts a conventional or UPM routing operation.

Alternatively, the initial predicate set 956 supplied to the CAM 220 may match a FIB entry 986, instead of initially matching the DoS TCP entry 980E. The resulting action contained in entry 986 may direct the SPU 200 to send the associated packet out through the output port to another device that provides the TCP DoS operation.

Network Address Translation (NAT)/Port Address Translation (PAT)

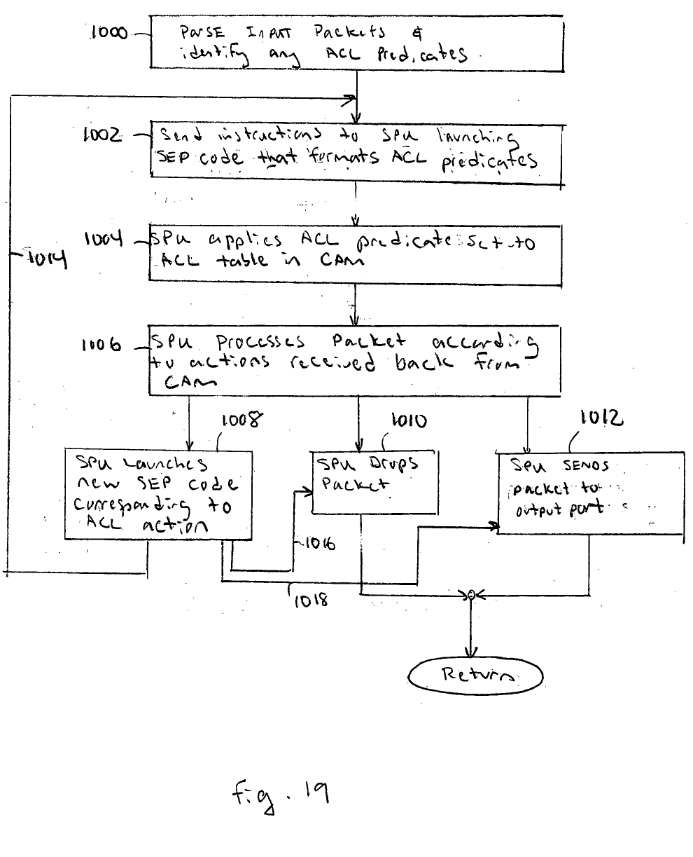

Referring to FIG. 20, the RSP 100 can be programmed for NAT/PAT operations that convert IP addresses and/or port numbers for packets traveling thru the firewall 1062 between public IP addresses that are used for transporting the packet over public network 12 and private IP addresses that are used for transporting the packet over the private network 24.

Typically there are multiple unique private IP addresses associated with different network processing devices operating in private network 24. However, only one, or a few, public IP addresses may be used to represent the multiple private IP addresses. This public-private address translation protects the identity of internal machines in private network 24 and reduces the number of public addresses required to map to multiple private addresses in private network 24.

In an alternative embodiment, one or more private IP addresses have an associated individual public IP address. This may not necessarily reduce the number of public IP addresses, but does allow the firewall 1062 to hide the corresponding private IP address from the public network 12. This one-to-one mapping also allows the firewall 1062 to reconfigure public IP addresses to different network devices in the private network 24.

The RSP 100 is configured to convert a public IP address 1058 for an incoming packet 1061 into a private IP address 1074. The private IP address 1074 is then used to route the internal packet 1076 to an associated network processing device 1078 in private network 24. The RSP 100 also receives packet 1072 from local device 1078 in private network 24 that contains a private IP address 1070. If the packet 1072 is directed to an endpoint 1056 in public network 12, the RSP 100 converts the private IP address 1070 into a public IP address 1052 that is used to route packet 1050 over public network 12 to endpoint 1056.

To explain in more detail, the device 1078 operating in private network 24 may initially send packet 1072 through firewall 1062 to a destination in public network 12. The RSP 100 receives the packet 1072 and converts the private source IP address 1070 to the public IP address 1052 associated with firewall 1062. The outgoing packet 1050 is also assigned a particular port number 1054 by the RSP 100. The RSP 100 then updates a lookup table 1064 by adding a private IP address entry 1068 and a corresponding port number entry 1066.

The device 1056 receiving the outgoing packet 1050 may send packet 1061 back to the local device 1078. The device 1056 uses the public IP source address 1052 and port number 1054 in packet 1050 as the destination address 1058 and port number 1060 for the packet 1061 sent back to local device 1078. The RSP 100 maps the destination address 1058 and port number 1060 in packet 1061 to the port number entries 1066 in lookup table 1064. The RSP 100 identifies the private IP address entry 1070 in lookup table 1079 corresponding with matching port number entry 1060.

The RSP 100 replaces the public destination IP address 1058 in packet 1061 with the identified private IP address 1070 from lookup table 1064. During the conversion between private and public IP addresses, the RSP 100 may de-assemble the packet, regenerate a checksum value and then re-assemble the packet.

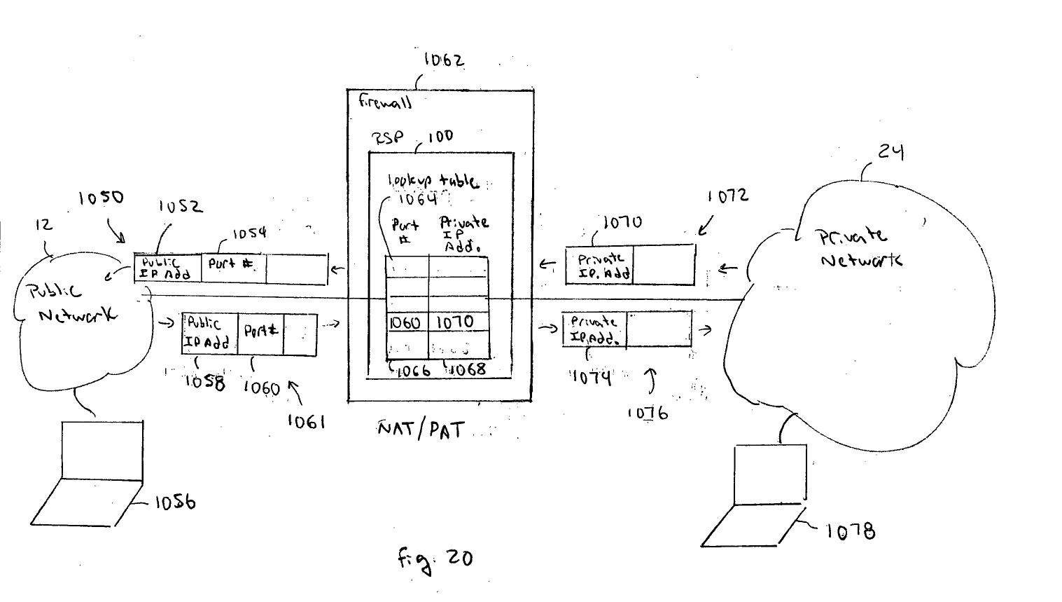

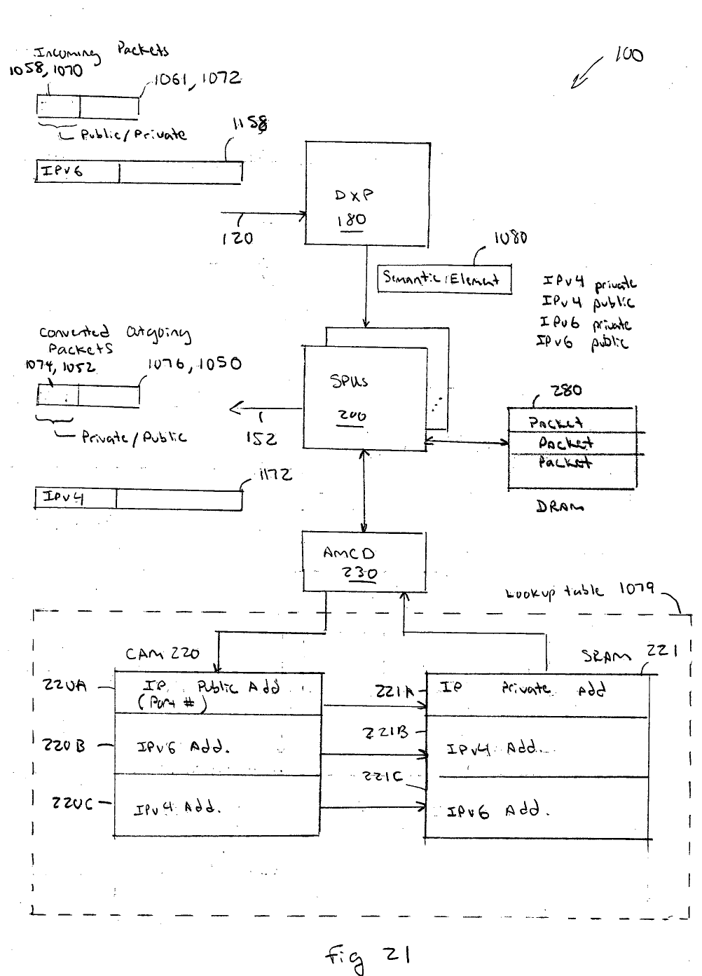

FIGS. 21-23 show in more detail one example of how the RSP 100 conducts the NAT/PAT conversions described above. The DXP 180 (FIG. 21) in operation 1100 (FIG. 22) parses the incoming packet received from the private network 24 and identifies the private IP source address 1070. The DXP 180 in operation 1102 signals the SPU 200 to load microinstructions from the SCT 210 for converting the private IP source address 1070 into a public IP source address.

The SPU 200 in operation 1104 generates the public IP address and port number for the packet. The public IP address is usually the IP address assigned to firewall 1062 (FIG. 20). In operation 1106, the SPU 200 loads the port number and corresponding private IP address for packet 1072 into the lookup table 1079. FIG. 21 shows one example of how the lookup table 1079 is implemented using the CAM 220 and SRAM 221. The SPU 200 stores the port numbers associated with the output packets 1050 into CAM location 220A through AMCD 230 and stores the corresponding private IP address 1070 as an entry 221A in SRAM 221.

In operation 1108, the SPU 200 replaces the private IP source address 1070 for the packet 1072 with the public source IP address 1052 that includes the associated port number 1054 (FIG. 20). The SPU 200 may also generate a new checksum for the outgoing packet 1050 in operation 1110. Finally, the SPU 200 in operation 1112 sends the packet 1050 with the public IP address 1052 and port number 1054 from DRAM 280 to the output port 152.

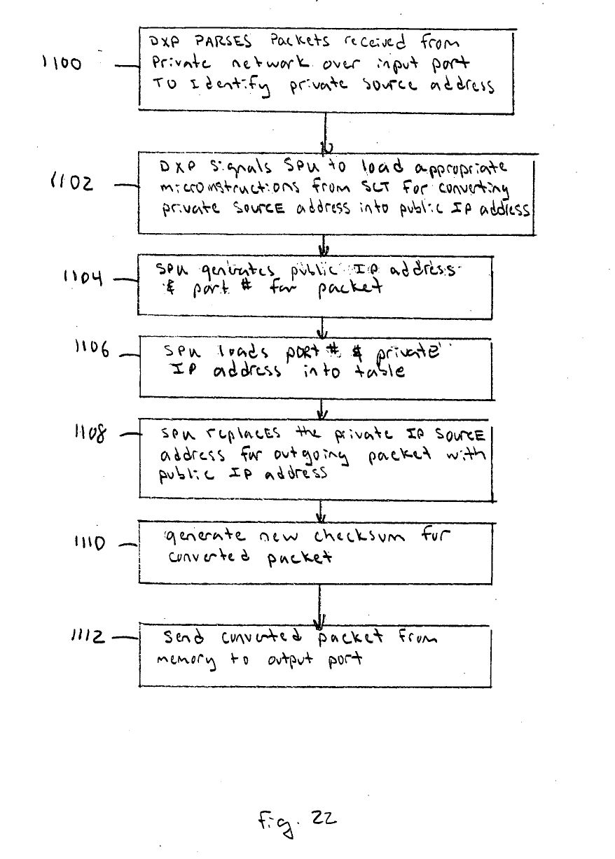

FIG. 23 describes how the RSP 100 converts the public destination IP address for incoming packets back into private IP addresses. In operation 1120, the DXP 180 parses the incoming packet 1061 received from the public network 12 and identifies the associated 5 tuple address. The DXP 180 in operation 1122 signals the SPU 200 to load microinstructions 212 from the SCT 210 (FIG. 2A) for converting the public IP destination address 1058 and port number 1060 into the corresponding private IP destination address 1074.

The SPU 200 in operation 1124 compares the public destination IP address 158 and port number 1060 from the incoming packet 1061 with the IP addresses and port number entries 220A in the lookup table 1079. For example, the SPU 200 uses the destination port number as an address into CAM 220. The address in section 220A matching the port number is used as a pointer into address section 221A in SRAM 221. In operation 1126, the SPU 200 reads the identified private destination IP address from SRAM 221 and replaces the public IP destination address 1058 for the packet with the identified private IP address 1074. In operation 1128, the SPU 200 may also generate a new checksum for the converted packet. Finally, the SPU 200 in operation 1130 outputs the packet 1076 from DRAM memory 280 to private network 24 over output port 152.

The RSP 100 may be configured to perform other modification and monitoring operations on the same packets either before or after the NAT/PAT operation. In this case, the SPU 200 may send the packet with the new private IP address 1074 from DRAM 280 back to the recirculation buffer 160 (FIG. 2A) for further firewall processing. The other firewall operations are then performed on the packet in recirculation buffer 160.

### IPv6/IPv4 Translation

Referring to FIG. 24, the firewall 1062 may need to convert between Internet Protocol version 4 (IPv4) and IP version 6 (IPv6), or convert between other IP protocol versions. For example, a first network 1150 may use IPv6 while a second network 1160 may use IPv4. The firewall 1062 therefore needs to translate the 128 bit address space 1158 for IPv6 packets 1156 to the 32 bit address space 1170 for IPv4 packets 1172. Other information in the headers and payload may also need to be converted between IPv4 and IPv6.

In one example, the firewall 1062 converts the IPv6 packet 1156 into a IPv4 packet 1172. In other example, the firewall 1062 encapsulates the IPv6 packet 1156 into an IPv4 tunnel 1164. Regarding the inverse translation, the firewall 1062 may convert IPv4 packets into IPv6 packets or encapsulate the IPv4 packets 1172 in IPv6 tunnels. These different conversions depend on the types of IP networks coupled to firewall 1062.

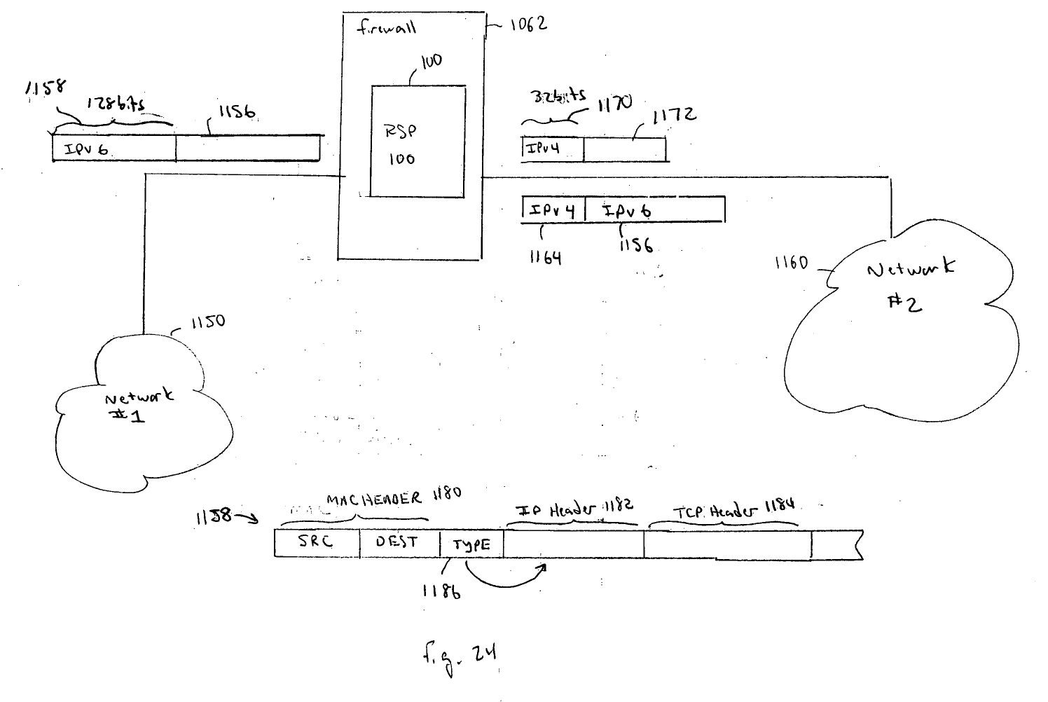

The incoming packet 1158 may include a Media Access Control (MAC) header 1180, IP header 1182, and TCP header 1184. A type field 1186 identifies the IP version number for the IP header 1182. Referring now to FIGS. 21, 24 and 25, the DXP 180 (FIG. 21) in operation 1200 (FIG. 25) parses the incoming packet 1158 to identify the particular IP version in field 1186. If the type field 1186 indicates IPv4, and the network connected to the opposite end of RSP 100 also uses IPv4, the DXP 180 may not launch any SEP code in the SPUs 200 for IP version translation.

However, if the type field 1186 indicates an IP version that is different than the IP version operating on the opposite end of RSP 100, then the DXP 180 in operation 1202 signals the SPU 200 to load microinstructions from the SCT 210 (FIG. 2A) for converting the incoming IP packet to the IP version for the other network. In this example, the microinstructions will cause the SPU 200 to translate an IPv6 packet into an IPv4 packet.

The SPU in operation 1204 applies the IPv6 address identified by the DXP 180 to section 220B in CAM 220 (FIG. 21) associated with 128 bit IPv6 addresses. The CAM 220 addresses a corresponding entry in section 221B of SRAM 221 that contains the corresponding 32 bit IPv4 address. The SPU 200 in operation 1206 reads the IPv4 address output from SRAM 221 and in operation 1208 replaces the IPv6 address in the packet with the identified IPv4 address. Alternatively, the SPU 200 may encapsulate the IPv6 packet in an IPv4 tunnel that uses the IPv4 address identified in SRAM 221. In operation 1210, the SPU 200 generates a new checksum and in operation 1212 sends the translated IPv4 packet, or the IPv4 tunnel containing the IPv6 packet, from DRAM 280 to output port 152.

A process similar to that described in FIG. 25 can also be used for converting incoming IPv4 packets to IPv6 packets. The same process described above can also be used to convert between any other IP packet versions that may exist in the future. The RSP 100 simply identifies the new IP version number that then launches a set of SEP code that is then used by the SPU 200 to convert the packets between a first IP version and a second IP version.

The IP version translation can also be combined with the unified policy management operations described above in FIGS. 13-19. For example, the RSP 100 can route packets identified with different IP versions to different associated IP subnets that may support the IP version identified in the packet.

One of the many unique characteristics of the RSP 100 is that additional packet processing operations can be preformed without requiring additional hardware and without substantial increases in software or processing state complexity. For example, the same RSP configuration shown in FIG. 21 for NAT/PAT conversions can also be used for translating between IPv4 and IPv6. The IPv6 to IPv4 address mappings 220B and 221B, respectively, and inverse IPv4 to IPv6 address mappings, 220C and 221C, respectively, can be stored in CAM 220 alongside the IP public and private addresses 220A and 220B used for NAT/PAT conversions. Further, processing the increased 128 bit IPv6 header only adds a few additional cycles to the overall packet processing rate for the RSP 100 since only a few additional clock cycles are required for parsing the larger IPv6 packet header.

Multiple different firewall operations can be more efficiently performed in the same RSP 100 by leveraging common DXP parsing. For example, the DXP 180 in FIG. 21 may conduct some of the same parsing operations for both NAT/PAT, and IPv6/IPv4 operations. For instance, the IP address is identified by the DXP 180 for both the NAT and IP version translations. The same DXP address parsing results can therefore be used for both the NAT and IP version translations. The DXP 180 therefore only requires a small amount of grammar in addition to the NAT grammar.

The RSP 100 is also not limited to processing any particular data size. Therefore, any IPv4 or IPv6 operation, or any other IP version or address size that may be developed in the future, is easily implemented using the same RSP architecture 100. The RSP 100 can be configured to process these different IP versions and address sizes simply by adding minimal new grammar to the DXP 180, additional SEP code for execution by the SPUs 200, and some additional entries in the CAM 220 and SRAM 221.

This is contrary to conventional hardware architectures that would require a complete redesign for efficiently processing IPv6 packets instead of IPv4 packets. For example, the data path sizes, register sizes, and logic elements in a conventional processor would have to be redesigned for the larger 128 bit IPv6 addresses.

### Virtual Private Network (VPN) Integration

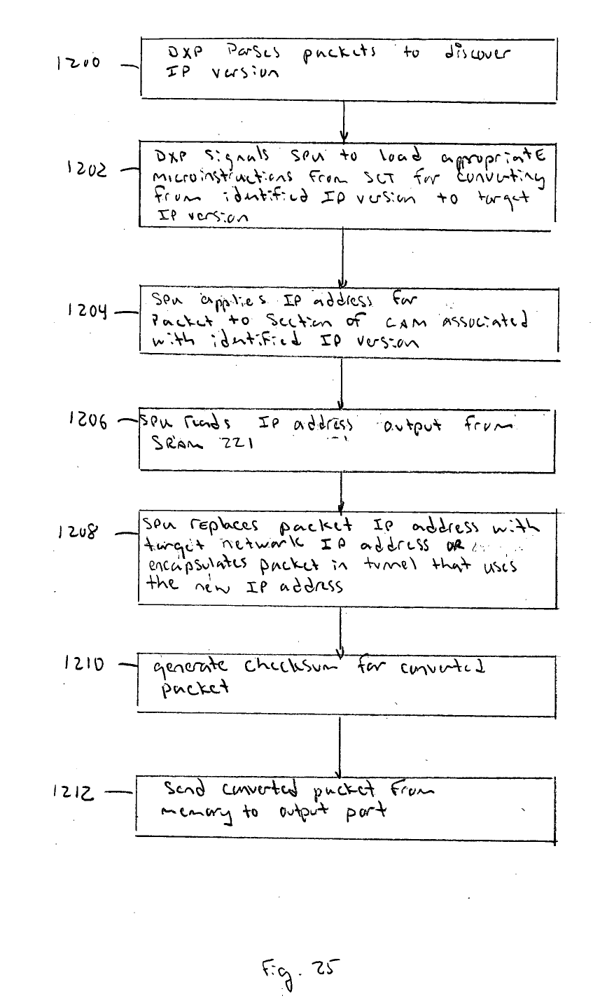

FIG. 26 shows one example of how a Virtual Private Network (VPN) tunnel 1207 is established across the Internet 1212. A computer 1216 may request a file 1200 from company server 1202. The server 1212 accesses the file 1200 and sends the file as IP packets 1204 back to the remote user 1216 through VPN/firewall 1206.

The firewall 1206 encapsulates the packets 1204 with a IP Security Protocol Encapsulating Security Payload (IPSec ESP) trailer 1210 and a IP Security Protocol Authentication Header (IPSec AH) 1208, such as IP Source Guard (IPSG). These IPSec headers 1208 and 1210 are located in the layer 3 protocol, after the IP header and before the upper layer protocol header when in transport mode, or before an encapsulated IP header when in tunnel mode. The IPSec ESP header 1210 and AH header 1208 can be used individually or in combination with one another.

The IPSec ESP header 1210 contains information necessary to decrypt the received packet and optionally an authentication digest necessary to authenticate the received packet 1204. The IPSec AH header 1208 contains an authentication digest necessary to authenticate the received packet 1204. When the IPsec packet 1218 contains an IPSec AH header 1208, the authenticating digest is located within the layer 3 protocol; otherwise, in IPSec ESP mode only the authentication digest is located after the packet's payload in the ESP trailer 1210.

The IPsec packet 1218 is transported over Internet 1212 as a VPN tunnel 1207 to computer 1216. The VPN/firewall 1214 decrypts the IPsec packet 1218 according to the information in AH header 1208 and ESP header 1210. The decrypted IP packet 1204 is then forwarded to computer 1216. The VPN/firewall 1214 may also conduct any of the other firewall operations on the decrypted packets 1204 as previously described above.

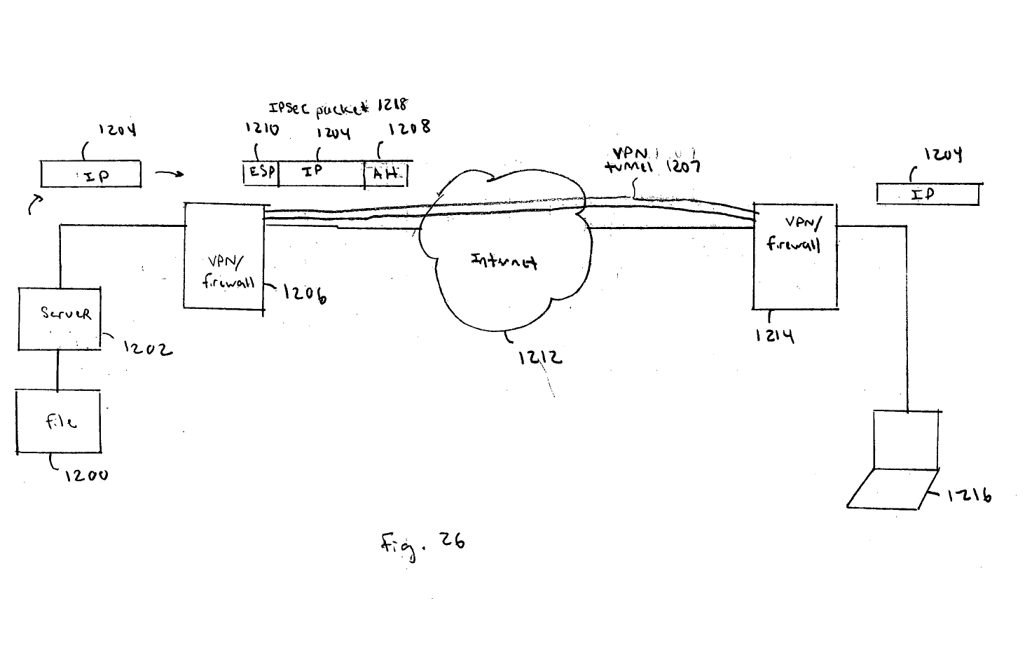

FIG. 27 shows in more detail the operations performed by the RSP 100 in the VPN/firewalls 1206 and 1214. The RSP 100 first conducts a preliminary DoS filtering 1220 to filter IPsec packets 1218 that are received above a DoS attack rate threshold. The DoS filtering 1220 may also filter any non-IPsec packets in a manner similar to what was described above in FIGS. 4-11.

A Security Association (SA) look up operation 1222 extracts the IP address, packet session identifiers, and Security Parameter Indices (SPIs) 1226 from the IPsec packet 1218 that identify the required decryption and authentication techniques to be used by the RSP 100. The SPIs 1226 and other IP information is submitted to a lookup table 1224 similar, or the same, as the lookup and ACL tables described above for DoS, UPM, NAT, and IP version translation. The lookup table 1224 returns back a decryption key 1228, a decryption algorithm identifier 1230, and an authentication algorithm identifier 1232.

The associated decryption algorithms transform the bits in the IPsec packet 1218 from an encrypted to an non-encrypted state. Examples of decryption algorithms include Data Encryption Standard (DES), Triple Data Encryption Standard (T-DES), Advanced Encryption Standard (AES), and T-DES in CBC mode. The authentication algorithms conduct a hash operation on the data to verify that the bits in IP packet 1204 are the same as the bits that were originally sent from server 1202. Examples of authentication algorithms include MD5 and SHA1.

The results from the SA lookup 1222 are provided to a decryption operation 1234 that then decrypts the IPsec packet 1218 back into original IP packet 1204. The specific details of how the SA lookup 1222 and decryption operation 1234 are performed are described in the following co-pending applications that are all herein incorporated by reference: MULTIPROCESSOR ARCHITECTURE WITH FLOATING DECRYPTION/ENCRYPTION/AUTHENTICATION BLOCKS, Ser. No. 11/127,445, filed May 11, 2005; IP SECURITY DECRYPTION/ENCRYPTION/AUTHENTICATION, Ser. No. 11/127,443, filed May 11, 2005; PIPELINED IP SECURITY DECRYPTION/ENCRYPTION/AUTHENTICATION, Ser. No. 11/127,468, filed May 11, 2005; and DEA Engine with DMA interface, Ser. No. 11/127,467, filed May 11, 2005.

The DXP 180 parses the incoming packets and identifies an IPsec packet 1218 according to an identified IP type field. The grammar in the DXP 180 then accordingly identifies the SPIs 1226 that are used by the DXP 180 to launch SEP code 212 (FIG. 2A). The SEP code 212 directs the SPUs 200 to apply the SPIs 1226 to the ACLs in CAM 220 and then conduct the decryption 1234 according to the results from a CAM lookup. For example, the decrypt key 1228, decrypt algorithm identifier 1230, and authentication algorithm identifier 1232 can be stored in the same CAM/SRAM structure described earlier in FIG. 21. The results for the CAM lookup are ACL actions that point to additional SEP code that executes the decryption algorithm associated with identifier 1230 and authentication algorithms associated with identifier 1232 using decryption key 1228.

If non-encrypted packets are received for the same IPsec session, for example, packets having the same 5-tuple, a corresponding ACL entry in the CAM 220 may direct the SPU 200 to drop the packets. This prevents an unauthorized attacker from taking over the VPN session 1207.

The decrypted IP packets are then sent to one or more different post decryption operations that may include a forwarding operation 1236 possibly similar to what was described above in the UPM application. For example, the RSP 100 in forwarding operation 1236 may simply forward the decrypted packet 1204 to the destination address without any further firewall operations using the FIB described in FIGS. 13-19.

Alternatively, the output from decryption 1234 may be passed through a second of DoS filtering 1238. The second DoS filtering 1238 can conduct DoS detection and filtering for the now decrypted IP address and other identifiers in IP packet 1204. For example, some of the predicates that are used for DoS and other UPM operations are now decrypted. The decrypted predicates are identified and then used to conduct the second DoS operation 1238, UPM, or any other required firewall operations.

The additional firewall operations may also include a TCP proxy operation 1240 as describe in co-pending patent application entitled: TCP ISOLATION WITH SEMANTIC PROCESSOR TCP STATE MACHINE, filed Jul. 14, 2005, Ser. No. ______ which is also herein incorporated by reference. In another possible post decryption operation 1240, the RSP 100 may convert the decrypted IP address into either a public or private address as described above in the NAT/PAT application.

Depending on what firewall operations are implemented and the type of decrypted IP packets 1204, the RSP 100 may conduct any combination of the post decryption operations 1236, 1238, 1240 or 1240. Of course, any of the other firewall operations discussed above can also be performed.

### Licensing Using Firewall Policy Management

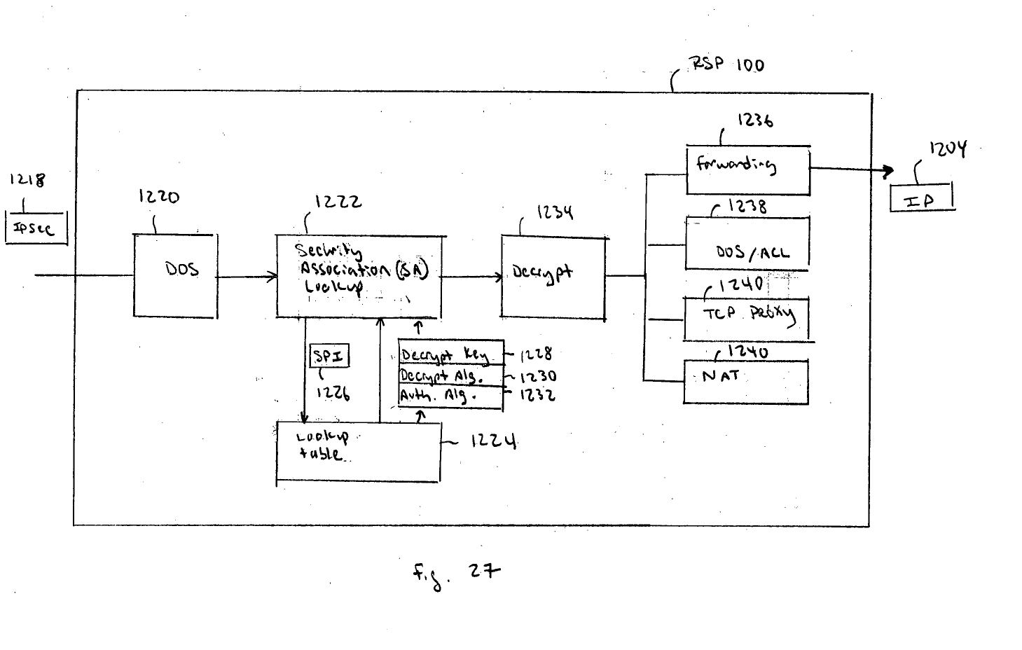

Referring to FIG. 28, an ACL table 1506 in combination with the RSP 100 can be used to more efficiently allocate Anti-Virus (AV) licenses. Currently, AV licenses are allocated to individual machines 1514. The problem is that these licenses are difficult to manage by a system administrator. For example, for every new machine 1514 that is added to a network, another license must be purchased and the AV software then installed. When the license agreement expires, the network administrator then has to reinstall or re-enable the AV software on the individual machine. Further, any updates to the AV software have to be individually loaded onto each computer 1514.

The RSP 100 provides centralized license management. For example, AV software 1504 can be operated by the RSP 100 in the firewall 1502 similar to the manner described in co-pending application entitled: METHOD AND APPARATUS FOR INTRUSION DETECTION IN A NETWORK PROCESSING DEVICE, filed May 9^{th}, 2005, Ser. No. 11/125,956. Alternatively, the AV software 1504 may be executed by a conventional network processing device.

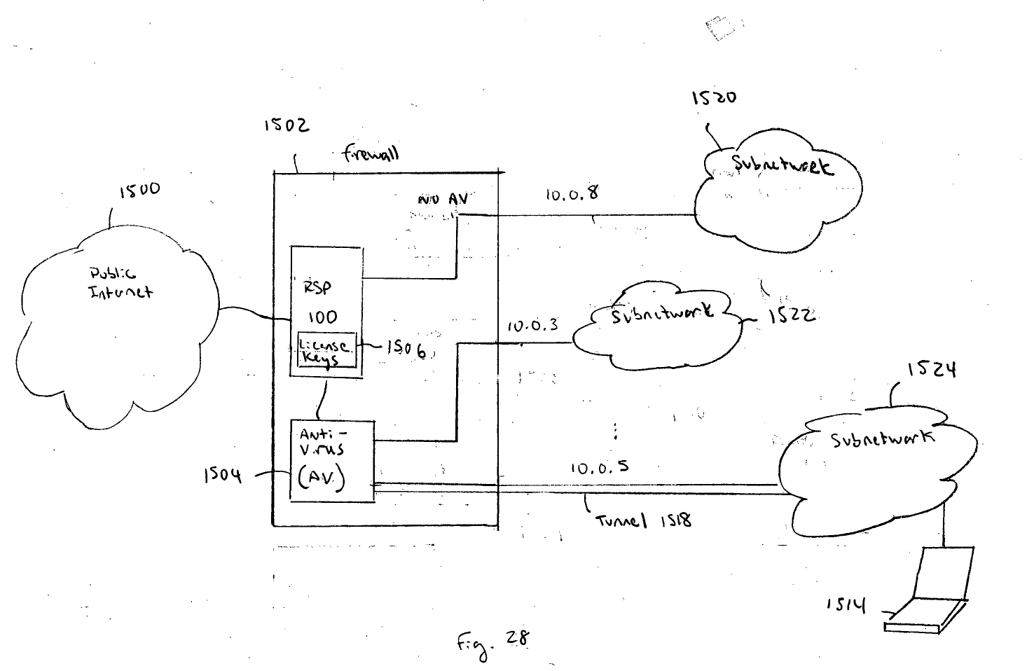

Regardless, the RSP 100 determines which sub-networks 1520, 1522 and 1524 have AV licenses and accordingly applies the AV software 1504 only to packets directed to those licensed sub-networks. Referring to FIGS. 28 and 29, the RSP 100 receives packets 1525 from public Internet 1500 having a particular destination address 1527. The DXP 180 in the RSP 100 identifies the IP destination address 1527 to SPU 200 and causes the SPU 200 to execute SEP code that, among other things, checks to see if the sub-network corresponding with the destination address 1527 has AV licenses.

For example, the SPU 200 submits the destination address 1527 for the packet to the CAM 220. The destination address 1527 may match the predicate 1528 in ACL entry 1526. The action 1530 associated with ACL entry 1526 indicates that there is a license for the sub-network 1522 (FIG. 28) associated with the packet destination address 1527 matching ACL predicate 1528. The action 1530 may be a pointer to additional SEP code that directs the SPU 200 to then determine if the number of connections currently established with sub-network 1522 is less than the number of allocated licenses. If the number of licenses purchased for sub-network 1522 is more than the number of active connections, the AV software 1504 is applied to the packet 1525.

The SPU 200, or other processing elements in the firewall 1502, can continuously maintain a count 1529 of the number of active connections between Internet 1500 and each sub-network 1520, 1522, and 1524. The memory 221 stores the active connection count 1529 and the number of licenses 1531 purchased for each sub-network connected to firewall 1502.

The SPU 200 can quickly determine if AV software 1504 should be applied to the packet 1525 by applying the already identified packet destination address 1527 to the CAM 220. The CAM 220 identifies the location in SRAM 221 that contains the current connection count 1529 and number of available licenses 1531 for the sub-network 1522. If one or more AV licenses are available, the SPU 200 applies AV software 1504 to the packet 1525 before, during, or after conducting other firewall operations.

If the sub-network is located over a public network, a tunnel may be established for any packets that pass through AV software 1504. For example, sub-network 1524 may be located at a remote location from firewall 1502. If sub-network 1524 has been allocated AV licenses, then the action 1530 in the corresponding ACL entry 1526 that matches addresses for sub-network 1524 will also direct the SPU 200 to encapsulate the packet in a secured tunnel 1518 before sending the packet to sub-network 1524.

The AV software 1504 will not be applied to sub-networks that do not have AV licenses. For example, no license key actions 1530 will be configured for ACL entries associated with sub-network 1520. Accordingly, RSP 100 will not apply AV 1504 to packets directed to sub-network 1520.

### RSP Arrays

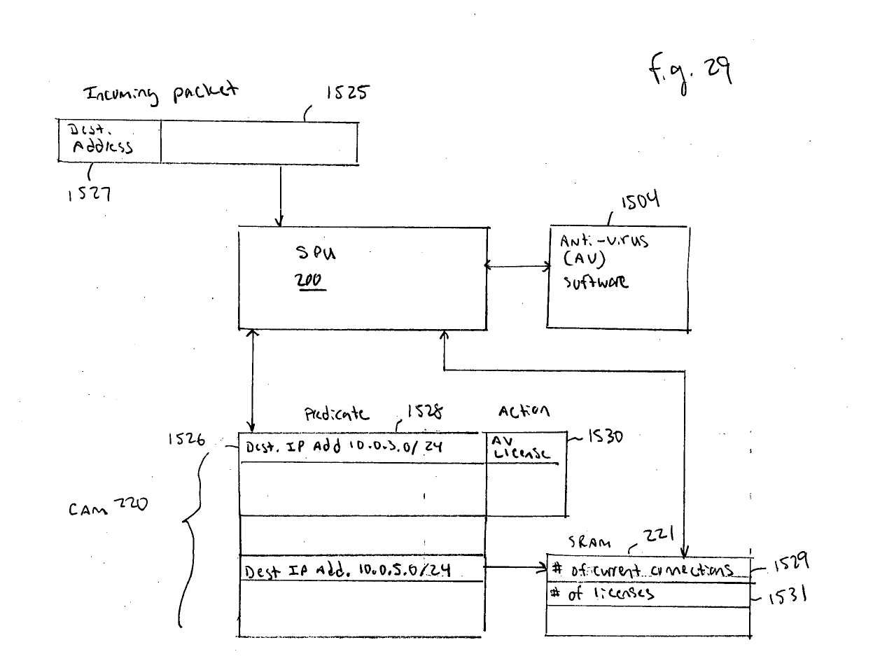

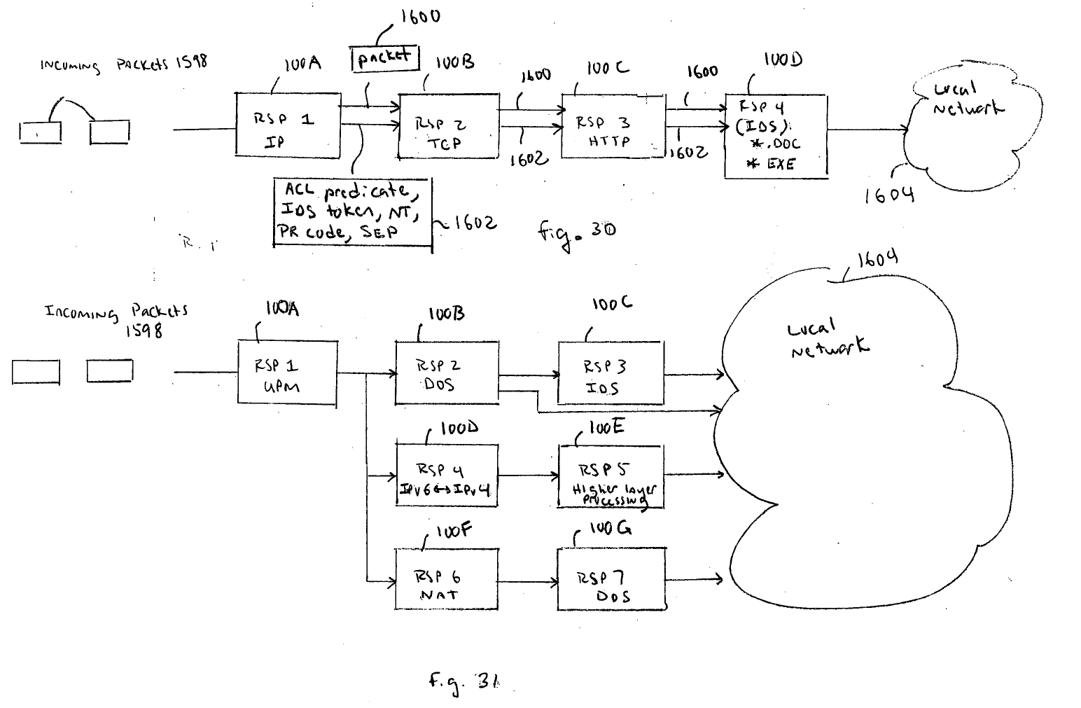

Referring to FIGS. 30 and 31, multiple RSPs 100 can be connected together to provide sequential or parallel firewall operations. For example, in FIG. 30 multiple RSPs 100A-100D are coupled together in series, each performing a different firewall, routing or Intrusion Detection System (IDS) operation. The first RSP 100A may identify and extract IP information from the incoming packets 1598 by extracting the 5 tuple source and destination IP address and port numbers.

The second RSP 100B may then perform operations related to TCP, such as managing TCP sessions and filtering any TCP packets associated with a DoS attack as described above in FIGS. 4-11. The RSP 100C may conduct packet processing operations that look for any HTTP sessions that may be carried in the packets. Finally, a RSP 100D may look for any text or executable files in the HTTP session that may contain a virus or other specific types of information, such as described in co-pending application: METHOD AND APPARATUS FOR INTRUSION DETECTION IN A NETWORK PROCESSING DEVICE, filed May 9^{th}, 2005, Ser. No. 11/125,956.

Of course any combination of RSPs 100 can perform any combination of different firewall and non-firewall operations and FIG. 30 shows only one example. It is important to note that each additional RSP provides a substantially linear increase in performance. For example, RSP 100A can forward any parsed firewall predicates, IDS tokens, Non-Terminals (NTs) 312, production codes 178, SEP code 177B (FIGS. 2B and 2C), etc. 1602 to the next RSP 100B. RSP 100B after completing packet processing may send similar state information 1602 to RSP 100C.

This prevents each subsequently following RSP 100 from having to repeat some of the same parsing already completed in the previous RSP. Further, the architecture of DXP 180 (FIG. 2A) allows each RSP 100 to immediately convert to the same state as the previous RSP simply by loading the NT 132 into parser stack 185 (FIG. 2A). For example, RSP 100A may identify an ACL predicate that contains the IP destination address. RSP 100A sends the ACL predicate and an associated NT 132 in message 1602 to RSP 100B along with the associated packet 1600. The RSP 100B can then start conducting TCP operations on packet 1600 using the already identified IP address information in the state where RSP 100A previously left off. Thus, RSP 100B is not required to reparse packet 1600, for example, to rediscover the destination IP address.

This is contrary to conventional processor architectures where packet processor states are not readily transferable. As a result, each additional conventional processor added to a packet processing system may not necessarily linearly increase overall network processing device performance. In other words, doubling the number of packet processing devices with conventional computer architectures does not necessarily result in doubling overall processing performance. Conversely, doubling the number of RSPs 100 can almost double the overall performance of the host network processing system.

FIG. 31 shows another alternative configuration of the RSP 100. In this configuration, one or more of the RSPs 100 operate in parallel. A first RSP 100A may conduct an initial UPM operation that determines based on the IP address and other predicates extracted from the packet what other firewall operations, if any, need to be performed on the incoming packets 1598. The RSP 100A when routes the packets to the RSPs 100B-G according to the identified firewall policy metrics.

For example, based on the identified firewall predicates, the packet 1598 may require DoS processing provided by RSP 100B. Accordingly, the RSP 100A routes the packets to RSP 100B. If RSP 100B determines that the destination subnet address for the packet has an associated IDS license as described above in FIGS. 28 and 29, then the packet may be routed to RSP 100C for anti-virus processing. Otherwise, the RSP 100B may forward the packets toward an endpoint in local network 1604.

If the UPM routing in RSP 100A determines that the packet needs to be translated to an IPv4 format, then the packet is routed to RSP 100D. The packet 1598 may then be sent to a RSP 100E that then processes the packet according to different higher OSI layer data. For example, the RSP 100E may route the packet according to HTTP information in the packet as described in FIG. 17. Other packets may be routed to RSPs 100F and 100G to conduct other NAT and DoS operations, respectively.

### Command Line Interface (CLI)/Logging/Statistics

Command Line Interface

Referring back to FIG. 2A, a Command Line Interface (CLI) 282 is coupled to the MCPU 56 and allows an operator at computer 284 to enter CLI commands and data 286 into the RSP 100. The MCPU 56 then interprets and acts upon the CLI commands 286 received from computer 284. For example, the CLI commands 286 may direct the MCPU 56 to load new ACL entries into the TCAM 220 in memory subsystem 215. The CLI commands 286 can also direct the MCPU 56 to load data into any other memory elements in memory subsystem 215.

The CLI commands 286 can also be used to configure the other storage elements and tables in the RSP 100. For example, the CLI commands 286 may direct the MCPU 56 to load new parser grammar into the parser table 170, production rules 176 into production rule table 190, or load new SEP code 212 into semantic code table 210. The CLI commands 286 can direct the MCPU 56 to read information from any one of the storage devices or tables in memory subsystem 215 or from other processing elements in the RSP 100.

Logging

The SEP code 212 can direct the SPU 200 to log certain detected events to the MCPU 56 for logging. For example, the SPU 200 may send any packet identified as part of a DoS attack to the MCPU 56. When the DoS attack is detected, the SEP code 212 directs the SPU 200 to send one exemplary dropped packet to the MCPU 56. The SEP code 212 may also direct the SPU 200 to notify the MCPU 56 every time a similar packet is dropped.

The MCPU 56 formats specific information contained in the dropped packet, and the statistics identifying the number of similarly dropped packets into a log. The log may be formatted into IP packets having an IP address of a syslog machine that then receives and logs the events detected in RSP 100. The packets containing the log may be sent by the SPU 200 to the syslog machine over output port 152.

Any detected events can be logged by the RSP 100 and can include, but is not limited to, any of the events identified in the firewall operations described above. For example, the SEP code 212 may also direct the SPUs 200 to send packets to the MCPU 56 that match particular ACL entries in CAM 220.

Statistics

Any required statistics can be recorded in the RSP 100 and either locally stored or sent to the logging system. For example, the SPU 200 can be programmed to count every received, dropped or output packet. The different SEP code 212 can include a logging command along with the other associated firewall operations. The RSP 100 identifies any statistical information associated with received or sent packets. For example, the number of packets received, size of the received packets, size and number of packets sent, the number of packets dropped, number of packets with bad checksums, number of duplicate packets, failed login attempts, etc. The statistics can be downloaded to computer 284 via CLI commands 286, or can be periodically sent in packets by the SPU 200 over output port 152.

Certification

Any of the firewall operations described above can be certified and can conform to different industry accepted certification standards including: Institute for Computer Security Association (ICSA), National Institute of Standards and Technology (NIST), University of New Hampshire (UNH), PLUG Fest, etc.

### Summation

The novel use of the RSP architecture in combination with an access control list more efficiently performs a variety of different firewall, UPM, or other packet processing operations with the same hardware and with minimal software reconfiguration. These multiple firewall operations can use the syntactic elements, such as predicates, that have been identified by the DXP or by other earlier firewall parsing operations. Thus, the RSP provides a more scalable firewall architecture.

As mentioned above, any of the operations described above may be implemented on any network processing device, and are not limited to operating on edge devices or what is conventionally referred to as a firewall. For example, the DoS, UPM and other operations may be performed in gateways, routers, servers, switches, and any other endpoint device. Further, many of the operations described above do not necessarily need to be implemented using the RSP 100 and can alternatively be implemented in conventional computer architectures.

The system described above can use dedicated processor systems, micro controllers, programmable logic devices, or microprocessors that perform some or all of the operations. Some of the operations described above may be implemented in software and other operations may be implemented in hardware.

For the sake of convenience, the operations are described as various interconnected functional blocks or distinct software modules. This is not necessary, however, and there may be cases where these functional blocks or modules are equivalently aggregated into a single logic device, program or operation with unclear boundaries. In any event, the functional blocks and software modules or features of the flexible interface can be implemented by themselves, or in combination with other operations in either hardware or software.

Having described and illustrated the principles of the invention in a preferred embodiment thereof, it should be apparent that the invention may be modified in arrangement and detail without departing from such principles. We claim all modifications and variation coming within the spirit and scope of the following claims.

1. A network processing device, comprising:
a processor associating packets with different levels of trusted communication and managing the packets that are part of a Denial of Service (DoS) attack according to the associated levels of trusted communication.

2. The network processing device according to claim 1 wherein the different levels of trusted communication are assigned according to different public and private interfaces receiving the packets.

3. The network processing device according to claim 1 wherein the processor determines when packets are part of a DoS attack according to a packet threshold rate corresponding to the associated level of trusted communication.

4. The network processing device according to claim 1 including a Content Addressable Memory (CAM) that contains DoS entries for packets associated with possible DoS attacks (DoS candidate packets).

5. The network processing device according to claim 4 wherein the DoS entries in the CAM are indexed according to a destination address.

6. The network processing device according to claim 5 including a DoS status memory that is indexed by the CAM and that contains different fields maintaining DoS status information for the different DoS entries.

7. The network processing device according to claim 6 wherein the DoS status memory includes DoS attack flags that identify DoS entries in the CAM that have been identified as part of a DoS attack.

8. The network processing device according to claim 6 wherein the DoS status memory includes a time stamp that tracks a number of associated DoS candidate packets received within a predetermined time period.

9. The network processing device according to claim 6 wherein the DoS status memory includes generations that associate the DoS entries with different logical sections of the CAM.

10. The network processing device according to claim 9 wherein the processor assigns DoS entries for incoming DoS candidate packets to a current generation in the CAM and may remove other DoS entries in an oldest generation for every new DoS entry assigned to the current generation, the processor upon receiving a packet associated with an existing DoS entry changing the previous generation for the existing DoS entry to the current generation.

11. A method for tracking rate limits for packets, comprising:
receiving packets having different associated packet addresses;
using different counters to track a number of packets received for the different associated packet addresses;
assigning timestamps for the different packet addresses; and
resetting the different counters only upon receiving a packet corresponding with a packet address that has an expired timestamp value.

12. The network processing device according to claim 9 wherein the processor circulates through the generations in the CAM at predetermined time intervals so that all generations are circulated through the CAM in less than an amount of time required for a time stamp associated with the DoS entries to wraparound to zero.

13. The network processing device according to claim 6 wherein the DoS status memory is a Static Random Access Memory (SRAM) that contains offset values that address counters in a Dynamic Random Access Memory (DRAM) that track a number of packets received during a predetermined time period for the different DoS entries.

14. A method for monitoring and filtering Denial of Service (DoS) attacks, comprising:
identifying a packet associated with a possible DoS attack;
tracking the status of the packet as a DoS entry in a memory;
allowing a new packet to pass when there is no previous DoS entry in the memory; and
adding a new DoS entry into the memory for the new packet after the new packet has already been allowed to pass.

15. The method according to claim 14 including:
receiving a packet that already has a DoS entry in the memory;
dropping the packet when a DoS attack flag in the corresponding DoS entry is set;
updating a time stamp, counter, and the DoS attack flag for the corresponding DoS entry when the time stamp is older than a predetermined time period.

16. The method according to claim 14 including:
receiving a packet that already has a DoS entry in the memory;
allowing the packet to pass when a DoS attack flag in the corresponding DoS entry is not set;
incrementing a counter for the corresponding DoS entry after the packet has been allowed to pass;
setting a DoS attack flag when the counter is above a DoS attack threshold and a time stamp for the corresponding DoS entry is within a predetermined time period.

17. The method according to claim 14 removing a DoS entry assigned to a next generation in the memory for every new DoS entry assigned to a current generation in the memory.

18. The method according to claim 17 including receiving a packet associated with an existing DoS entry in the memory and changing the previous generation for the existing DoS entry to a current generation.

19. The method according to claim 18 including circulating through each generation in the memory at predetermined time intervals where the combined time to circulate through all of the generations in the memory is less than the amount of time required for a time stamp associated with the DoS entry to wraparound to zero.

20. A firewall, comprising:
a processor identifying Denial of Service (DoS) candidate packets that are associated with a possible Denial of Service (DoS) attack;
a Content Addressable Memory (CAM) containing DoS entries that index the DoS candidate packets according to an associated destination address; and
a status memory indexed by the CAM and containing DoS status for the different DOS entries.

21. The firewall according to claim 20 wherein the DoS entries are also indexed according to interface zones associated with different levels of trusted communication for received packets.

22. The firewall according to claim 20 wherein the CAM is partitioned into logical generation regions that the processor cycles through at periodic time periods or when the generation regions are filled with DoS entries, the processor assigning new DoS entries to a current generation region and removing DoS entries from a next generation region.

23. The firewall according to claim 22 including generation tables that the processor accesses to identify which locations in the CAM do not contain DoS entries and to identify where the DoS entries are located for each generation region.

24. The firewall according to claim 20 wherein the processor includes:
a direct execution parser that parses incoming packets to identify the DoS candidate packets; and
one or more Semantic Processing Units (SPUs) that identify the DoS candidate packets that are part of a DOS attack allowing the DoS candidate packets that are not part of the DOS attack to pass through the firewall while dropping the DoS candidate packets that are identified as a part of the DOS attack.

25. A network processing device, comprising:
a processor configured to use a same memory subsystem as a Forwarding Information Base (FIB) and for firewall policy management.

26. The network processing device according to claim 25 wherein the processor compares a destination address and firewall policy metrics contained in the packets with a same set of Access Control List (ACL) entries in the memory subsystem for making both routing or switching decisions and for performing firewall operations.

27. The network processing device according to claim 25 wherein the ACL entries include predicates corresponding with the destination address and firewall policy metrics in the packets and actions that indicate what firewall or forwarding operations to perform on the packets.

28. The network processing device according to claim 25 wherein the processor includes:
a data parser configured to identify an address and firewall metrics in packets; and
one or more Semantic Processing Units (SPUs) that perform both firewall operations and packet forwarding operations on the packets according to the identified address and firewall metrics.

29. The network processing device according to claim 28 including a Content Addressable Memory (CAM) that contains an Access Control List (ACL) table, the SPUs combining the identified address and firewall metrics identified by the data parser into predicate sets that are then applied to the CAM to identify associated firewall and forwarding actions.

30. The network processing device according to claim 29 wherein the CAM includes a conversion table that is used by the SPUs to convert addresses in the packets between a public IP address and a private address.

31. The network processing device according to claim 29 including a conversion table that is used in combination with the CAM to convert the packets between different IP version formats.

32. The network processing device according to claim 31 wherein the same CAM contains conversion tables for both converting the addresses in the packets between a public IP address and a private address and converting the packets between different IP version formats.

33. The network processing device according to claim 29 including ACL entries in the CAM that identify encrypted packets that are part of a Virtual Private Network (VPN) tunnel and direct the SPUs to decrypt the identified encrypted packets.

34. The network processing according to claim 28 wherein the ACL table includes ACL entries that identify packets directed to sub-networks having virus detection licenses and cause the SPUs to conduct virus detection on the identified packets.

35. A semantic processor, comprising:
a parser that parses packets to identify syntactic elements associated with network interface operations, the parser then launching microinstructions according to the identified syntactic elements; and
one or more Semantic Processing Units (SPUs) that conduct the network interface operations by executing the microinstructions launched by the direct execution parser.

36. The semantic processor according 35 including:
an input port configured to receive data symbols;
a direct execution parser stack storing stack symbols, the parser processing stack symbols in response to the received data symbols;
a parser table populated with production rule codes indexable by the combination of at least one received data symbol and a symbol supplied by the parser;
a production rule table populated with production rules indexable by production rule codes; and
a semantic code table accessible by the SPUs and populated with machine instructions indexed by the production rule codes.

37. The semantic processor according to claim 35 wherein the parser identifies Denial of Service (DOS) packets that are possibly part of a DOS attack, the parser causing the SPUs to monitor a rate that the DoS candidate packets are received and either drop or pass the DoS candidate packets according to the monitored rate.

38. The semantic processor according to claim 35 including an Access Control List (ACL) that includes entries having predicates corresponding with packet semantic elements identified by the parser and actions that are used by the one or more SPUs to determine what firewall operations to perform on the packets.

39. The semantic processor according to claim 38 including a Forwarding Information Base (FIB) including destination addresses and corresponding output ports, the one or more SPUs using a combination of the predicates from the ACL and the destination addresses from the FIB to determine how to forward and process the packets.

40. The semantic processor according to claim 39 wherein the ACL includes different Uniform Resource Locator (URL) predicates associated with different output ports for the same destination address predicate, the parser identifying a destination address and URL value contained in the packets and the SPUs forwarding the packets to the output port identified in the ACL having a matching destination address predicate and URL predicate.

41. The semantic processor according to claim 35 including a Network Address Translation and/or Port Address Translation (NAT/PAT) lookup table that maps public addresses with private addresses, the parser identifying the public or private addresses in the packets and directing the one or more SPUs to replace the private or public address with the corresponding public or private address from the lookup table.

42. The semantic processor according to claim 35 including an Internet Protocol (IP) version translation table that maps addresses for a first IP version format with corresponding addresses for a second IP version format, the parser identifying the IP version format used in the packets and directing the SPUs to replace the addresses in the packets with a different address for the other IP version format.

43. The semantic processor according to claim 35 including a Virtual Private Network (VPN) table that associates a decryption key, decryption algorithm identifier, and/or authentication algorithm identifier with associated Security Parameter Indices (SPIs), the parser identifying the SPIs in packets and directing the SPUs to apply the identified SPIs to the VPN table and then decrypt the packets according to the decryption key, decryption algorithm identifier, and/or authentication algorithm identifier received back from the VPN table.

44. The semantic processor according to claim 35 including an anti-virus table that associates different sub-networks with anti-virus licenses, the parser identifying destination addresses in packets and directing the SPUs to apply the destination addresses to the anti-virus table and conduct anti-virus operations on the packets identified as being directed to sub-networks with anti-virus licenses.
